(19) United States
(12) Patent Application Publication
(10) Pub. No.: US 2009/0103630 A1
(43) Pub. Date: Apr. 23, 2009

(54) IMAGE PROCESSING DEVICE

(76) Inventors: Ryuji Fuchikami, Fukuoka (JP); Ikuo Fuchigami, Fukuoka (JP); Tadanori Tezuka, Fukuoka (JP)

Correspondence Address: WENDEROTH, LIND & PONACK L.L.P., 1030 15th Street, N.W., Suite 400 East, Washington, DC, 20005-1503, US

(21) Appl. No.: 12/029,903

(22) Filed: Feb. 12, 2008

(30) Foreign Application Priority Data
Feb. 13, 2007 (JP) 2007-031801

(51) Int. Cl. H04N 7/26; H04N 5/228

(52) U.S. Cl. 375/240.25; 348/362; 375/E07.027; 348/E05.031

(57) ABSTRACT

An image processing device comprising: an imaging unit outputting frames of image data sequentially in order of imaging; a first generation unit generating first image data sequentially in units of a predetermined number of consecutive frames of image data, from the output frames of image data, wherein a total exposure time of each piece of first image data is a first time period; a second generation unit generating second image data sequentially in units of the predetermined number of consecutive frames, from the output frames of image data, a total exposure time of each piece of second image data is a second time period different from the first time period; and an output unit outputting each pair of first image data and second image data generated from a same set of the predetermined number of consecutive frames of image data, in correlation with each other.

### BACKGROUND OF THE INVENTION

(1) Field of the Invention

The present invention relates to a technology of processing moving image data, specifically to a technology of generating a plurality of pieces of moving image data and a technology of compress encoding and playing back each piece of moving image data.

(2) Description of the Related Art

Normally, frames of image data that constitute the moving image data are generated with an exposure time that corresponds to the frame rate at which the moving image is played back (hereinafter, the frame rate is referred to as “normal rate”).

When, for example, the normal rate is 30 fps (frames per second), each frame of image data is generated with an exposure time of approximately 1/30 seconds. When the moving image data obtained in this way is played back at the normal rate, the displayed moving image appears to move smoothly.

Meanwhile, the moving image data obtained in this way may be played back at a rate different from the normal rate. For example, the moving image may be played back slowly when the moving image data is edited. A problem recognized in such a case is that a blurred image is displayed when a moving image of a fast moving object is played back slowly. This is because each frame of image data contains what is called “object blurring” when the move of the object is so fast.

Frames of image data with less object blurring can be obtained when the images are taken with an exposure time (hereinafter referred to as “short exposure time”) that is shorter than an exposure time corresponding to the normal rate (hereinafter, the exposure time corresponding to the normal rate is referred to as “long exposure time”). Thus, when the frames of image data generated with the short exposure time are played back in the slow playback or the like, clear images with less object blurring are displayed.

As a technology for taking images with different exposure times, known is, for example, a technology for taking still images temporarily with a short exposure time while a moving image is taken (see, for example, Japanese Patent Application Publication No. 2006-50308, page 8, FIG. 1. Hereinafter, this document is referred to as “Patent Document 1”). Here, the contents of Patent Document 1 will be described.

FIG. 15 is a functional block diagram of an imaging device 1000 in Patent Document 1.

As shown in FIG. 15, the imaging device 1000 includes a control unit 1001, an imaging unit 1002, a switch unit 1003, a long exposure image recording unit 1004, and a short exposure image recording unit 1005.

Upon receiving an instruction for starting to take moving image from the user via an operation unit (not illustrated), the control unit 1001 of the imaging device 1000 sets the switch unit 1003 to connect to the long exposure image recording unit 1004, and controls the imaging unit 1002 to generate each frame of image data with the long exposure time. With this operation, frames of image data generated with the long exposure time are output sequentially from the imaging unit 1002, and then recorded into the long exposure image recording unit 1004.

Upon receiving, from the user via the operation unit, an instruction for taking a still image while a moving image is being taken, the control unit 1001 sets the switch unit 1003 to connect to the short exposure image recording unit 1005, and controls the imaging unit 1002 to take a still image with the short exposure time. With this operation, apiece of still image data generated with the short exposure time is output from the imaging unit 1002, and then recorded into the short exposure image recording unit 1005.

When recording of the still image data is completed, the control unit 1001 sets the switch unit 1003 to connect to the long exposure image recording unit 1004, and controls the imaging unit 1002 to generate each frame of image data with the long exposure time. With this operation, frames of image data generated with the long exposure time are output sequentially from the imaging unit 1002 again, and then recorded into the long exposure image recording unit 1004.

As described above, the imaging device 1000 of Patent Document 1 can take a still image with the short exposure time while it is taking a moving image that is composed of frames of images taken with the long exposure time.

Also known is a technology for switching from a playback of moving image data to a display of a still image that was taken while the moving image was being taken (see, for example, Japanese Patent Application Publication No. 2004-304425, page 18, FIG. 6). Hereinafter, this document is referred to as “Patent Document 2”). Here, the electronic camera recited in Patent Document 2 will be described briefly.

The electronic camera recited in Patent Document 2, as is the case with Patent Document 1, can take a still image while taking a moving image. The data of the still image is recorded together with information indicating the time when the still image was taken (the length of time elapsed from the start of taking the moving image).

The electronic camera of Patent Document 2 can also play back the moving image data and still image data of the taken images. And when a still image is taken while a moving image is being taken and the moving image data thereof is played back, information indicating the presence of the still image is displayed as a frame of image data that was taken near the still image is displayed. When the user sees the information and performs a certain operation, the electronic camera of Patent Document 2 switches the display from the moving image to the still image.

By combining the technologies disclosed in Patent Documents 1 and 2, it is possible to display a moving image moving smoothly and switch the display from the moving image to a still image with less object blurring after a frame of image data that was taken near the still image is displayed.

As a general technology for processing moving images, known are, for example, a technology for compress encoding a plurality of pieces of moving image data (see, for example, Japanese Patent Application Publication No. 2002-344972, page 31, FIG. 1. Hereinafter, this document is referred to as “Patent Document 3”) and a technology for generating frames of image data with the long exposure time by combining a plurality of frames of image data that were taken with a certain exposure time (see, for example, Japanese Patent Application Publication No. 2004-48421, page 9, FIG. 1. Hereinafter, this document is referred to as “Patent Document 4”). The structure of the moving image encoding device of Patent Document 3 is shown in FIG. 17 of the present application, and the structure of the imaging device of Patent Document 4 is shown in FIG. 18 of the present application.

However, according to a technology obtained by combining the technologies of Patent Documents 1 and 2, the user can switch the display from the moving image to a clear still image with less object blurring only when the playback elapsed time of the moving image (the length of time elapsed from the starting frame) approaches the time when the still image was taken.

With the combined technology, however, it is not possible, at an arbitrary timing, to switch the display from a playback of moving image data at the normal rate to an image with less object blurring (for example, a slow playback). This is because, according to the method of Patent Document 1, a still image is taken only upon receiving an instruction from the user, thus an image having been taken with the short exposure time is not necessarily be present at the arbitrary timing when the user desires to display it.

### SUMMARY OF THE INVENTION

The object of the present invention is therefore to provide an image processing device that outputs a plurality of sets of image data that are structured to provide clear display for various playback purposes at any arbitrary timing.

The above object is fulfilled by an image processing device comprising: an imaging unit operable to output frames of image data sequentially in order of imaging; a first generation unit operable to generate pieces of first image data sequentially in units of a predetermined number of consecutive frames of image data, from the frames of image data output sequentially from the imaging unit, wherein a total exposure time of each piece of first image data is a first time period; a second generation unit operable to generate pieces of second image data sequentially in units of the predetermined number of consecutive frames of image data, from the frames of image data output sequentially from the imaging unit, wherein a total exposure time of each piece of second image data is a second time period different from the first time period; and an output unit operable to, for each pair of a piece of first image data and a piece of second image data that are generated from a same set of the predetermined number of consecutive frames of image data, output the piece of first image data and the piece of second image data in correlation with each other.

Here, the total exposure time means an exposure time with which an image of an object is taken to generate a frame of image data that is output from the imaging unit, or means an exposure time of combined image data which is generated by combining a plurality of frames of image data.

Also, the combining means to perform, for each of all pixels constituting one frame of image data, a process of obtaining a sum of pixel values of a plurality of frames of image data for a same pixel position, or obtaining a result value of dividing the sum by the number of the plurality of frames, and determines the obtained sum or the result value as the pixel value of the combined image data for the same pixel position.

With the above-stated structure, the image processing device of the present invention can generate first image data and second image data whose total exposure times are different from each other, for each process target, namely for each set of the predetermined number of frames of image data. Accordingly, in the case where the first time period is a total exposure time shorter than the second time period that is a total exposure time that corresponds to the normal rate, and the first and second image data are generated, it is possible to achieve smooth moving image display by playing back the second image data at the normal rate, and it is possible to achieve display of a clear image with less blurring by performing a slow playback or the like using the first image data.

Also, since a piece of first image data and a piece of second image data that are output in each pair correlate with each other, it is possible to switch from a playback of the second image data to a playback of the corresponding first image data, at an arbitrary timing.

As described above, the image processing device of the present invention enables the first and second image data to be played back clearly at any playback timing, depending on the purpose such as a playback at the normal rate or a slow playback.

In the above-described image processing device, each piece of first image data generated by the first generation unit may be one frame of image data selected from each set of the predetermined number of consecutive frames of image data, each piece of second image data generated by the second generation unit is combined image data that is generated by combining two or more frames of image data including a corresponding piece of first image data, among the predetermined number of consecutive frames of image data, and the output unit assigns a sequential number indicating a predetermined order to at least one of the piece of first image data and the piece of second image data in each pair that are to be correlated with each other and are to be output.

With the above-stated structure wherein the second generation unit combines two or more frames of image data that include the frame of image data (first image data) selected by the first generation unit, it is possible to generate second image data with a total exposure time longer than a total exposure time of the first image data.

In the above-described image processing device, the two or more frames of image data that are combined by the second generation unit may be three or more frames of image data that include, among the predetermined number of frames of image data, two frames of image data that are before and after the corresponding piece of first image data in order of output from the imaging unit.

With the above-stated structure, the second generation unit generates the second image data by combining the frame of image data (first image data) selected by the first generation unit, and two frames of image data that are before and after the first image data output by the imaging unit. Accordingly, the total exposure time of the first image data is contained in the total exposure time of the second image data. Namely, the image processing device of the present invention can generate the first image data and the second image data whose total exposure times are different from each other, but correspond to each other in the center time.

In the above-described image processing device, the predetermined number may be an odd number, said one frame of image data selected by the first generation unit is, among the predetermined number of frames of image data, a frame of image data that is positioned at center of a sequence of frames of image data arranged in order of output from the imaging unit, and the three or more frames of image data that are combined by the second generation unit are all of the predetermined number of frames of image data.

With the above-stated structure, the first generation unit selects one frame of image data being a frame of image data that is positioned at the center of a sequence of frames of image data arranged in order of output from the imaging unit, among the predetermined number of frames of image data. It is therefore possible to generate a frame of image data (first image data) that was taken in a time period that is the center of the total exposure time of the second image data. Namely, the image processing device of the present invention can generate the first image data and the second image data whose total exposure times are different from each other, but have the same center time.

Further, by setting the predetermined number of frames of image data to be a relatively larger number, it is possible to generate the first image data and the second image data whose total exposure times are different from each other relatively greatly.

In the above-described image processing device, the imaging unit may generate each frame of image data with a same exposure time as the first time period, and outputs the generated frame of image data.

With the above-stated structure, the imaging unit generates each frame of image data with a same exposure time as the first time period. This enables the second generation unit to generate the second image data whose total exposure time is an integral multiple of the total exposure time of the first image data.

In the above-described image processing device, each of the predetermined number of frames of image data may be generated by the imaging unit either with a same exposure time as the first time period or with an exposure time that is a third time period different from the first time period, and said one frame of image data selected by the first generation unit is, among the predetermined number of frames of image data, a frame of image data that has been generated with the same exposure time as the first time period.

With the above-stated structure, it is possible to generate the first image data and the second image data whose total exposure times are different from each other, even if the imaging unit takes images with different exposure times.

In the above-described image processing device, the first time period may be shorter than the third time period.

With the above-stated structure, the third time period is longer than the first time period. Therefore, compared with the case where the imaging unit takes images with a constant exposure time being the first time period, the second generation unit generates the second image data with a total exposure time being the second time period, by performing the combining a less number of times.

The above-described image processing device may further comprise: a first motion vector detecting unit operable to detect a first motion vector from each piece of first image data output from the output unit; and a first compress encoding unit operable to compress encode each piece of second image data output from the output unit, using each first motion vector detected by the first motion vector detecting unit from each corresponding piece of first image data.

Here, compress encoding image data using the first motion vector means to compress encode the second image data based on the first motion vector detected by the first motion vector detecting unit, and also means to search the second image data for a motion vector using the first motion vector as the initial value, and compress encode the second image data based on the motion vector obtained by the re-search.

With this structure, the second image data generated by the second generation unit is combined data that is generated by combining two or more frames of image data that include the frame of image data (first image data) selected by the first generation unit. Therefore, it is highly possible that the second image data and the corresponding first image data represent images that resemble each other. That is to say, if a motion vector of the second image data is detected, the level of match between motion vectors detected from the second image data and from the corresponding first image data is relatively high.

Accordingly, the image processing device of the present invention can perform compress encoding by maintaining the compression rate even in the case where the second image data is compress encoded based on the first motion vector detected from the first image data, which corresponds to the second image data, by the first motion vector detecting unit.

The above-described image processing device may further comprise: a difference extracting unit operable to generate difference data that shows difference between each piece of first image data and each corresponding piece of second image data output from the output unit; and a compress encoding unit operable to compress encode each piece of difference data output from the difference extracting unit.

The above-described image processing device may further comprise: a difference extracting unit operable to generate difference data that shows difference between each piece of first image data and each corresponding piece of second image data output from the output unit; and a first compress encoding unit operable to generate encoded difference data by compress encoding each piece of difference data output from the difference extracting unit.

With the above-stated structures, it is highly possible that the second image data and the corresponding first image data represent images that resemble each other. In such a case, the difference data generated by the difference extracting unit is relatively small in size. Therefore, it is possible to achieve efficient compress encoding by compress encoding the difference data.

In the above-described image processing device, the imaging unit may generate each frame of image data with an exposure time that is a third time period shorter than the first time period, and outputs the generated frame of image data, each piece of first image data generated by the first generation unit is combined image data that is generated by combining two or more frames of image data among the predetermined number of frames of image data, and each piece of second image data generated by the second generation unit is combined image data that is generated by combining three or more frames of image data including the two or more frames of image data that are combined by the first generation unit.

With the above-stated structures, the first generation unit can generate the first image data whose total exposure time is the first time period, even if the imaging unit takes images with an exposure time (third time period) that is shorter than the first time period. It is therefore possible to achieve an image processing device having higher general-purpose properties in terms of the exposure time when the imaging unit takes images.

The above-described image processing device may further comprise a second compress encoding unit operable to compress encode each piece of first image data output from the output unit, using each first motion vector detected by the first motion vector detecting unit from said each piece of first image data.

With the above-stated structures, the first image data and the corresponding second image data are compress encoded, using the first motion vector detected from the first image data by the first motion vector detecting unit. That is to say, when the second image data is compress encoded using the first motion vector, no motion vector is detected from the second image data. Accordingly, the image processing device of the present invention has a reduced amount of process for the compress encoding as a whole of the device.

In the above-described image processing device, the output unit may assign a sequential number indicating a predetermined order to at least one of each piece of first image data and each piece of second image data that correlate with each other and are to be output, the image processing device further comprising: a decoding unit operable to generate image data by decoding either each piece of encoded first image data encoded by the second compress encoding unit, or each piece of encoded second image data encoded by the first compress encoding unit, and output the generated image data; a playback unit operable to play back the image data output from the decoding unit; a receiving unit operable to receive an instruction for changing a playback speed; and a decoding control unit operable to, when the playback unit is playing back a piece of first image data when the receiving unit receives the instruction for changing the playback speed, cause the decoding unit to decode a piece of encoded second image data that is generated by encoding a piece of second image data corresponding to a piece of first image data that is, in the predetermined order, immediately after the piece of first image data being played back, and operable to, when the playback unit is playing back a piece of second image data, cause the decoding unit to decode apiece of encoded first image data that is generated by encoding a piece of first image data corresponding to a piece of second image data that is, in the predetermined order, immediately after the piece of second image data being played back.

With the above-stated structures, when the receiving unit receives, for example, an instruction for changing a playback speed from the user, played back is a piece of image data that corresponds to a piece of image data that is, in the predetermined order, immediately after the piece of first or second image data being played back. Accordingly, in the case where the first time period is a total exposure time shorter than the second time period that is a total exposure time that corresponds to the normal rate, and the first and second image data are generated, it is possible to achieve smooth moving image display by playing back the second image data at the normal rate, and it is possible to achieve display of a clear image with less blurring by performing a slow playback or the like using the first image data.

Also, since a piece of first image data and a piece of second image data that are output in each pair correlate with each other, any time when the receiving unit receives an instruction for changing a playback speed, it is possible to switch from a playback of the second image data to a playback of the corresponding first image data.

The above-described image processing device may further comprise: a second motion vector detecting unit operable to detect a second motion vector from each piece of second image data output from the output unit, using each first motion vector detected from each corresponding piece of first image data, wherein the first compress encoding unit compress encodes each piece of second image data output from the output unit, using each second motion vector detected from said each piece of second image data.

With the above-stated structures, the second motion vector detecting unit detects a second motion vector from each piece of second image data output from the output unit, using each first motion vector detected from each corresponding piece of first image data. Namely, it is possible to detect the second motion vector using the first motion vector as the initial value. Therefore, the image processing device of the present invention has a reduced amount of process for the compress encoding as a whole of the device, compared with the case where motion vectors are detected from the second image data separately, not based on the first motion vector.

The above-described image processing device may further comprise: a motion vector detecting unit operable to detect a motion vector from each piece of second image data output from the output unit; a first compress encoding unit operable to compress encode each piece of first image data output from the output unit, using each motion vector detected by the motion vector detecting unit from each corresponding piece of second image data; and a second compress encoding unit operable to compress encode each piece of second image data output from the output unit, using each motion vector detected from said each piece of second image data.

With the above-stated structures, the second image data and the corresponding first image data are compress encoded, using the motion vector detected from the second image data by the motion vector detecting unit. That is to say, when the first image data is compress encoded using the detected motion vector, no motion vector is detected from the first image data. Accordingly, the image processing device of the present invention has a reduced amount of process for the compress encoding as a whole of the device.

The above-described image processing device may further comprise: a second compress encoding unit operable to generate pieces of encoded second image data by compress encoding each piece of second image data output from the output unit, and output the generated pieces of encoded second image data in correspondence with encoded difference data that have been generated by compress encoding pieces of difference data that respectively show difference from pieces of second image data from which the pieces of encoded second image data are generated.

With the above-stated structures, the encoded difference data and the encoded second image data, which was used for generating the difference data from which the encoded difference data was generated, are output in correspondence with each other. Therefore, it is possible to clearly identify the encoded difference data and the encoded second image data to be decoded that correspond to each other, when a certain piece of first image data is to be played back.

In the above-described image processing device, the output unit may assign a sequential number indicating a predetermined order to at least one of each piece of first image data and each piece of second image data that correlate with each other and are to be output, the image processing device further comprising: a decoding unit operable to generate second image data by decoding one of a plurality of pieces of encoded second image data encoded by the second compress encoding unit and output the generated second image data, or further generate difference data by decoding encoded difference data corresponding to the plurality of pieces of encoded second image data, and output the generated difference data and the generated second image data; a combining unit operable to generate first image data by combining the difference data and the second image data output from the decoding unit, and output the generated first image data; a playback unit operable to play back either the second image data output from the decoding unit or the first image data output from the combining unit; a receiving unit operable to receive an instruction for changing a playback speed; and a decoding control unit operable to, when the playback unit is playing back a piece of first image data when the receiving unit receives the instruction for changing the playback speed, cause the decoding unit to decode a piece of encoded second image data that is generated by encoding a piece of second image data corresponding to a piece of first image data that is, in the predetermined order, immediately after the piece of first image data being played back, and operable to, when the playback unit is playing back a piece of second image data, cause the decoding unit to decode a piece of encoded second image data that is generated by encoding a piece of second image data that is, in the predetermined order, immediately after the piece of second image data being played back, and cause the decoding unit to decode a piece of encoded difference data that correspond to the decoded piece of second image data.

With the above-stated structures, even in the case where each piece of first image data is encoded as a difference data showing difference from each corresponding piece of second image data, any time when the receiving unit receives an instruction for changing a playback speed from the user, the decoding control unit performs a control on which data should be decoded by the decoding unit, depending on whether the image data currently played back by the playback unit is the first image data or the second image data. As a result of this, it is possible to switch between playbacks of the first and second image data at any playback timing, because a piece of image data (second image data when first image data is being played back, or first image data when second image data is being played back) corresponding to a piece of image data that is, in the predetermined order, immediately after the piece of image data being played back is decoded or combined to be displayed.

In the above-described image processing device, the output unit may assign a sequential number indicating a predetermined order to at least one of each piece of first image data and each piece of second image data that correlate with each other and are to be output, the image processing device further comprising: a playback unit operable to play back either the first image data or the second image data output from the output unit; a receiving unit operable to receive an instruction for changing a playback speed; and a playback control unit operable to, when the playback unit is playing back a piece of first image data when the receiving unit receives the instruction for changing the playback speed, cause the playback unit to play back a piece of second image data that correspond to a piece of first image data that is, in the predetermined order, immediately after the piece of first image data being played back, and operable to, when the playback unit is playing back a piece of second image data, cause the playback unit to play back a piece of first image data that correspond to a piece of second image data that is, in the predetermined order, immediately after the piece of second image data being played back.

With the above-stated structures, for example, in the case where the first time period is a total exposure time shorter than the second time period that is a total exposure time that corresponds to the normal rate, it is possible to achieve smooth moving image display by playing back the second image data at the normal rate, and it is possible to achieve display of a clear image with less blurring by performing a slow playback or the like using the first image data.

Also, any time when the receiving unit receives an instruction for changing a playback speed from the user, the playback control unit causes the playback unit to play back a piece of image data (second image data when first image data is being played back, or first image data when second image data is being played back) corresponding to a piece of image data that is, in the predetermined order, immediately after the piece of image data being played back. Accordingly, it is possible to play back image data clearly at any playback timing, depending on the purpose such as a playback at the normal rate or a slow playback.

The above object is also fulfilled by an image processing device comprising: an obtaining unit operable to sequentially obtain pairs of a piece of first image data and a piece of second image data which correlate with each other, in a predetermined order, from among a plurality of pieces of first image data and a plurality of pieces of second image data that are stored in an external storage device in correspondence with each other, wherein a total exposure time of each piece of first image data is a first time period, a total exposure time of each piece of second image data is a second time period different from the first time period, and a sequential number indicating the predetermined order is assigned to at least one of each piece of first image data and each piece of second image data that correlate with each other; a motion vector detecting unit operable to detect a motion vector from each piece of first image data obtained by the obtaining unit; a first compress encoding unit operable to compress encode each piece of second image data obtained by the obtaining unit, using each motion vector detected by the motion vector detecting unit; and a second compress encoding unit operable to compress encode each piece of first image data obtained by the obtaining unit, using each motion vector detected by the motion vector detecting unit.

With the above-stated structures, the first image data and the corresponding second image data are compress encoded, using the motion vector detected from the first image data by the motion vector detecting unit. That is to say, when the second image data is compress encoded using the motion vector, no motion vector is detected from the second image data. Accordingly, the image processing device of the present invention has a reduced amount of process for the compress encoding as a whole of the device.

The above object is also fulfilled by an image processing device comprising: an obtaining unit operable to sequentially obtain pairs of a piece of first image data and a piece of second image data which correlate with each other, in a predetermined order, from among a plurality of pieces of first image data and a plurality of pieces of second image data that are stored in an external storage device in correspondence with each other, wherein a total exposure time of each piece of first image data is a first time period, a total exposure time of each piece of second image data is a second time period different from the first time period, and a sequential number indicating the predetermined order is assigned to at least one of each piece of first image data and each piece of second image data that correlate with each other; a difference extracting unit operable to generate difference data that shows difference between each piece of first image data and each corresponding piece of second image data obtained by the obtaining unit; and a compress encoding unit operable to compress encode each piece of difference data output from the difference extracting unit.

With the above-stated structures, it is highly possible that the second image data and the corresponding first image data represent images that resemble each other. In such a case, the difference data generated by the difference extracting unit is relatively small in size. Therefore, it is possible to achieve efficient compress encoding by compress encoding the difference data.

The above object is also fulfilled by an image processing device comprising: an obtaining unit operable to obtain either a piece of first image data or a piece of second image data from among a plurality of pieces of first image data and a plurality of pieces of second image data that are stored in an external storage device in correspondence with each other, wherein a total exposure time of each piece of first image data is a first time period, a total exposure time of each piece of second image data is a second time period different from the first time period, and a sequential number indicating the predetermined order is assigned to at least one of each piece of first image data and each piece of second image data that correlate with each other; a playback unit operable to play back image data obtained by the obtaining unit; a receiving unit operable to receive an instruction for changing a playback speed; and an obtaining control unit operable to, when the playback unit is playing back a piece of first image data when the receiving unit receives the instruction for changing the playback speed, cause the obtaining unit to obtain a piece of second image data corresponding to a piece of first image data that is, in the predetermined order, immediately after the piece of first image data being played back, and operable to, when the playback unit is playing back a piece of second image data, cause the obtaining unit to obtain a piece of first image data corresponding to a piece of second image data that is, in the predetermined order, immediately after the piece of second image data being played back.

With the above-stated structure, the obtaining control unit cause the obtaining unit to obtain a piece of image data (second image data when first image data is being played back, or first image data when second image data is being played back) corresponding to a piece of image data that is, in the predetermined order, immediately after the piece of image data being played back is decoded or combined to be displayed. Therefore, it is possible to switch between playbacks of the first and second image data at any playback timing.

In the above-described image processing device, the instruction for changing the playback speed received by the receiving unit may specify a playback speed after change, and the obtaining control unit, when the playback unit is playing back a piece of second image data when the receiving unit receives the instruction specifying a playback speed after change that is smaller than a first threshold value, causes the obtaining unit to obtain a piece of first image data corresponding to a piece of second image data that is, in the predetermined order, immediately after the piece of second image data being played back, and when the playback speed after change specified in the instruction received by the receiving unit is equal to or greater than the first threshold value, causes the obtaining unit to obtain a piece of second image data that is, in the predetermined order, immediately after the piece of second image data being played back.

With the above-stated structure, when three or more play back speeds (for example, the normal rate, ½ of the normal rate, and ¼ of the normal rate) need to be provided, any time when the receiving unit receives the instruction specifying a playback speed after change that is smaller than a first threshold value (for example, the normal rate), namely, when the specified playback speed is ½ of the normal rate or ¼ of the normal rate, it is possible to switch to a playback of the first image data.

In the above-described image processing device, the obtaining control unit, when the playback unit is playing back a piece of first image data when the receiving unit receives the instruction specifying a playback speed after change that is equal to or greater than a second threshold value that is greater than the first threshold value, may cause the obtaining unit to obtain a piece of second image data corresponding to a piece of first image data that is, in the predetermined order, immediately after the piece of first image data being played back, and when the playback speed after change specified in the instruction received by the receiving unit is smaller than the second threshold value, causes the obtaining unit to obtain a piece of first image data that is, in the predetermined order, immediately after the piece of first image data being played back.

With the above-stated structure, when three or more play back speeds (for example, the normal rate, ½ of the normal rate, and ¼ of the normal rate) need to be provided, any time when the receiving unit receives the instruction specifying a playback speed after change that is greater than the first threshold value being ½ of the normal rate, the playback is switched to a playback of the second image data only when the playback speed specified in the instruction is equal to or greater than the second threshold value (for example, the normal rate) that is greater than the first threshold value. Accordingly, even when an instruction to switch to a playback speed near the first threshold value is frequently received, the display is not switched. This enables the process load for the switching process to be reduced.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a functional block diagram of an image processing device 100 in Embodiment 1 of the present invention;

FIG. 2 is a timing chart showing the operation of the image processing device 100;

FIG. 3 illustrates relationships between the long exposure image data and the short exposure image data generated by the image processing device 100;

FIG. 4 illustrates relationships between the long exposure image data and the short exposure image data generated by the image processing device of Modification 1;

FIG. 5 is a functional block diagram of an image processing device 200 in Embodiment 2 of the present invention;

FIG. 6 is a flowchart showing the operation of the image processing device 200;

FIG. 7 shows an example of image data sequences that are respectively obtained by the image processing device 100 and the imaging device 1000 when they take images of the same object;

FIG. 8 is a functional block diagram of an image processing device 300 in Embodiment 3 of the present invention;

FIG. 9 is a flowchart showing the operation of the image processing device 300;

FIG. 10 is a functional block diagram of an image processing device 400 in Embodiment 4 of the present invention;

FIG. 11 illustrates the structure of an encoded data sequence in the MPEG-4 AVC format to be recorded in the long and short exposure moving image recording unit 440;

FIG. 12 is a flowchart showing the operation of the image processing device 400;

FIG. 13 is a functional block diagram of an image processing device 500 in Embodiment 5 of the present invention;

FIG. 14 is a flowchart showing the operation of the image processing device 500;

FIG. 15 is a functional block diagram of the imaging device 1000 in Patent Document 1;

FIG. 16 illustrates relationships between the frames of image data generated with a long exposure time and the still image data generated with a short exposure time that are generated by the imaging device 1000 in Patent Document 1;

FIG. 17 is a functional block diagram showing the structure of the moving image encoding device of Patent Document 3; and

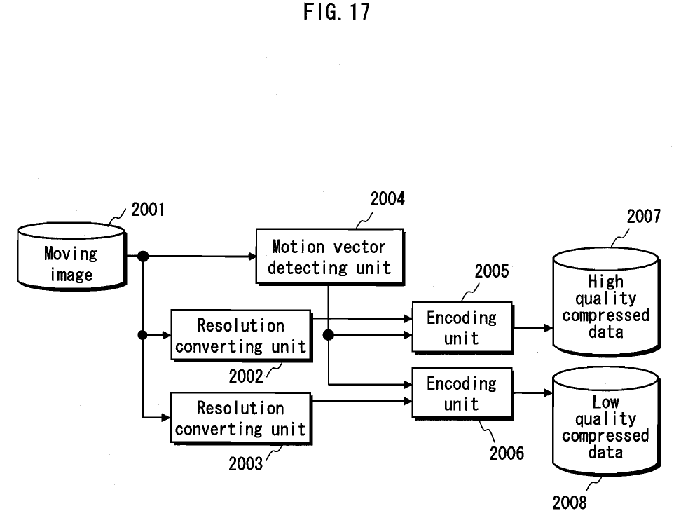

FIG. 18 is a functional block diagram showing the structure of the imaging device of Patent Document 4.

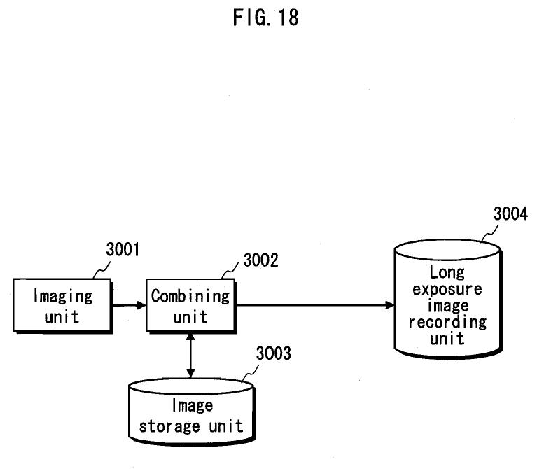

### DESCRIPTION OF THE PREFERRED EMBODIMENT

The following describes several preferred embodiments of the present invention, with reference to the attached drawings.

### Embodiment 1

### <Overview>

The image processing device of Embodiment 1 is an improvement of a conventional image processing device (imaging device) having an image taking function. The image processing device of Embodiment 1 obtains frames of image data in sequence as it takes images of an object, and by using the obtained image data, it generates two types of moving image data that are composed of frames of image data with two different exposure times.

The image processing device of Embodiment 1 obtains frames of image data in sequence as it takes images of an object with a predetermined exposure time. The image processing device of Embodiment 1 then performs the following process for each predetermined number of frames of image data (hereinafter, the predetermined number is referred to as “combination number”) in sequence in order of image taking. The combination number may be any number, but is “9” for example.

More specifically, the image processing device of Embodiment 1 generates image data whose total exposure time is equal to a result of multiplying the combination number by the exposure time of each frame image data at the image taking (hereinafter the image data generated by combining a plurality of pieces of image data is referred to as “long exposure image data”). The image processing device then selects a frame of image data that is positioned at the center of a sequence of frames of image data to be combined together (in this example, the fifth frame of image data in a sequence of nine frames of image data), where the frames of image data in the sequence are arranged in order of image taking (hereinafter the selected image data is referred to as “short exposure image data”). The image processing device records the long exposure image data in correspondence with the short exposure image data.

That is to say, the image processing device of Embodiment 1 can generate a plurality of pieces of long exposure image data and a plurality of pieces of short exposure image data in correspondence with each other, where the total exposure time of the long exposure image data is equal to a result of multiplying the combination number by the exposure time of each frame image data at the image taking, and the total exposure time of the short exposure image data is the same as the exposure time at the image taking.

A set of long exposure image data obtained in this way can be used to play back a moving image at a normal rate. This provides display of smooth motions. Also, a set of short exposure image data can be used in a slow playback. This provides display of clear images with less blurring.

Further, since a plurality of pieces of long exposure image data and a plurality of pieces of short exposure image data are recorded in correspondence with each other, it is possible to switch from a playback at the normal rate to a slow playback by switching from a playback of the long exposure image data to a playback of the short exposure image data starting with a piece of short exposure image data that corresponds to a piece of long exposure image data immediately after a piece of long exposure image data at which the moving image playback stops.

### <Structure>

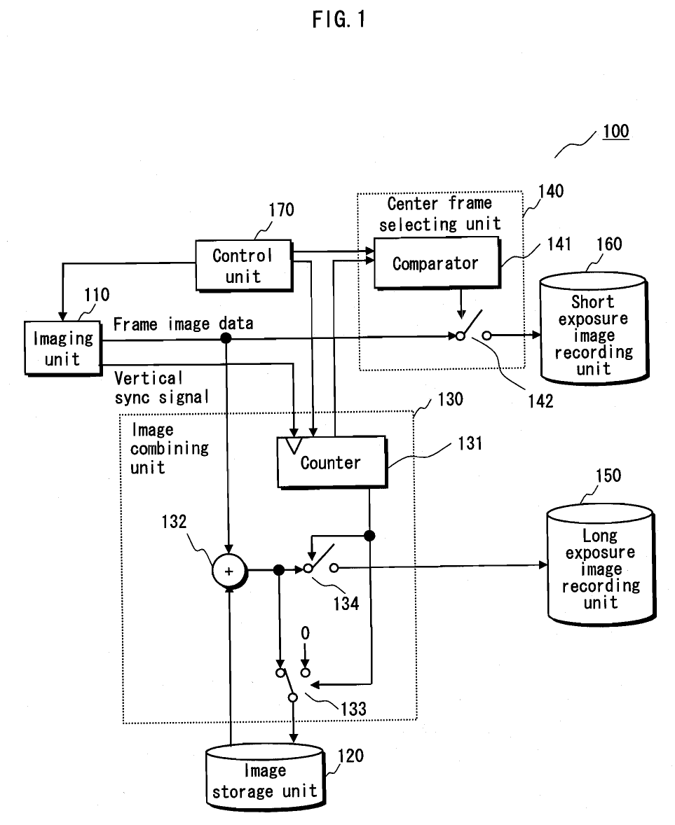

FIG. 1 is a functional block diagram of an image processing device 100 in Embodiment 1 of the present invention.

As shown in FIG. 1, the image processing device 100 includes an imaging unit 110, an image storage unit 120, an image combining unit 130, a center frame selecting unit 140, a long exposure image recording unit 150, a short exposure image recording unit 160, and a control unit 170.

The imaging unit 110 includes a lens, a CCD (Charge Coupled Device), an analog to digital converter and the like, and has a function to generate frames of image data in sequence with a predetermined exposure time in accordance with an instruction from the control unit 170, and transmits the generated frames of image data in order of generation.

More specifically, the imaging unit 110 generates the frames of image data (each frame of image data is, for example, a set of brightness data representing 640×480 pixels) by collecting the light that comes from the imaging object into the CCD using the lens, causing the CCD to convert the light into an electrical signal, and causing the analog to digital converter to convert the electrical signal into a digital signal. The imaging unit 110 sends the generated frames of image data to the image combining unit 130 and the center frame selecting unit 140, and sends a vertical sync signal to the image combining unit 130.

The image storage unit 120 is a memory, and has a function to temporarily store the combined image data which is generated by the image combining unit 130, where the combined image data will be described later.

The image combining unit 130 generates long exposure image data by combining each set of as many frames of image data as the combination number (for example, “9”), in a sequence of frames of image data generated by the imaging unit 110, and records the generated long exposure image data into the long exposure image recording unit 150, where the total exposure time of each piece of long exposure image data is equal to a result of multiplying the exposure time at the image taking by the combination number.

The following describes one example of hardware structure for achieving the function of the image combining unit 130, the structure including a counter 131, a combiner 132, and switches 133 and 134.

Each time it receives a vertical sync signal from the imaging unit 110, namely, each time the imaging unit 110 sends out the frames of image data generated therein, the counter 131 increases a count value and sends the increased count value to the center frame selecting unit 140.

In the counter 131, the combination number has been set by the control unit 170 preliminarily, and when the count value reaches the combination number, the counter 131 carries over and outputs a switch signal to change the connection state of each of the switch 133 and the switch 134. It should be noted here that, when the counter 131 carries over, it resets the count value to the initial value of “0”.

The combiner 132 generates a new piece of combined image data by combining a piece of combined image data stored in the image storage unit 120, with a frame of image data received from the imaging unit 110, and overwrites data in the image storage unit 120 with the new piece of combined image data. The combiner 132 continues this operation until the counter 131 carries over.

It should be noted here that combining means to add up brightness values of pixels of the same pixel position in the piece of combined image data and the frame of image data, and sets the result of the addition to the brightness value of the corresponding pixel in the new piece of combined image data. This process is performed onto each of pixels constituting one frame of image data. The grayscale (brightness) bit value of the pixels of the new piece of combined image data is greater than that of each frame of image data.

When the counter 131 carries over, the counter 131 outputs a switch signal to change the connection state of each of the switch 133 and the switch 134. When this happens, the combiner 132 records the new piece of combined image data (long exposure image data generated by combining a predetermined number of frames of image data) into the long exposure image recording unit 150, not into the image storage unit 120.

It should be noted here that in this example of hardware structure, the long exposure image data generated by combining a predetermined number of frames of image data is recorded into the long exposure image recording unit 150. However, not limited to this, results of dividing each pixel value of the long exposure image data by the combination number (in this example, “9”) may be recorded into the long exposure image recording unit 150.

After the connection state of each of the switch 133 and the switch 134 is changed, the image storage unit 120 is initialized to “0”, namely, the combined image data is deleted from the image storage unit 120.

After the long exposure image data is recorded into the long exposure image recording unit 150 and the image storage unit 120 is initialized, the switches 133 and 134 return to the original states.

The center frame selecting unit 140 selects a frame of image data that is positioned at the center of a sequence of frames of image data to be combined together by the image combining unit 130, where the frames of image data in the sequence are arranged in order of transmission from the imaging unit 110 (equivalent with the order of image taking). The center frame selecting unit 140 records the selected frame of image data into the short exposure image recording unit 160.

The following describes one example of hardware structure for achieving the function of the center frame selecting unit 140, the structure including a comparator 141 and a switch 142.

In the comparator 141, the control unit 170 has preliminarily set a number (hereinafter referred to as “selection number”) indicating a frame of image data that is to be selected from among a sequence of frames of image data to be combined, where in the present embodiment, the frame of image data to be selected is positioned at the center of the sequence of frames of image data. For example, when the sequence of frames to be combined consists of nine frames, the number indicating the frame to be selected is “5” since it indicates the frame positioned at the center of the sequence of nine frames arranged in order of transmission.

The comparator 141 compares the selection number with the count value received from the counter 131. Only when the selection number matches the count value, the comparator 141 outputs a switch signal to the switch 142 to activate the switch 142 so that one frame of image data transmitted from the imaging unit 110 is recorded into the short exposure image recording unit 160.

Each of the long exposure image recording unit 150 and the short exposure image recording unit 160 is achieved by a recording medium such as a memory or a hard disk. The long exposure image recording unit 150 has a function to store the long exposure image data generated by the image combining unit 130. The short exposure image recording unit 160 has a function to store each frame of image data (short exposure image data) selected by the center frame selecting unit 140. It should be noted here that the long exposure image recording unit 150 and the short exposure image recording unit 160 may be physically achieved by one memory, one hard disk or the like.

A plurality of pieces of long exposure image data are recorded consecutively into consecutive areas in the long exposure image recording unit 150 in the order where the pieces of image data are generated. Also, a plurality of pieces of short exposure image data are recorded consecutively into consecutive areas in the short exposure image recording unit 160 in the order where the pieces of image data are generated. It should be noted here that the term “consecutive” used here means “logically consecutive”, as well as “physically consecutive”. That is to say, when a file system is used, the image data pieces may be recorded consecutively in a file.

With this structure, it is possible to correlate a piece of long exposure image data and a piece of short exposure image data that are arranged at a same position in generation order. Thus, for example, when a moving image playback is performed by playing back each piece of long exposure image data in generation order, the moving image playback may be switched to a playback of the short exposure image data starting with a piece of short exposure image data that corresponds to a piece of long exposure image data immediately after a piece of long exposure image data at which the moving image playback stops.

The control unit 170 includes a processor and a memory, and has a function to perform various controls by executing a program stored in the memory. More specifically, the control unit 170 sets the combination number into the counter 131, sets the selection number into the comparator 141, and sets the exposure time at image taking and the image taking rate into the imaging unit 110. Upon receiving, from the user, an instruction for starting an image taking via an operation unit that is not illustrated, the control unit 170 causes the imaging unit 110 to start the image taking.

### <Operation>

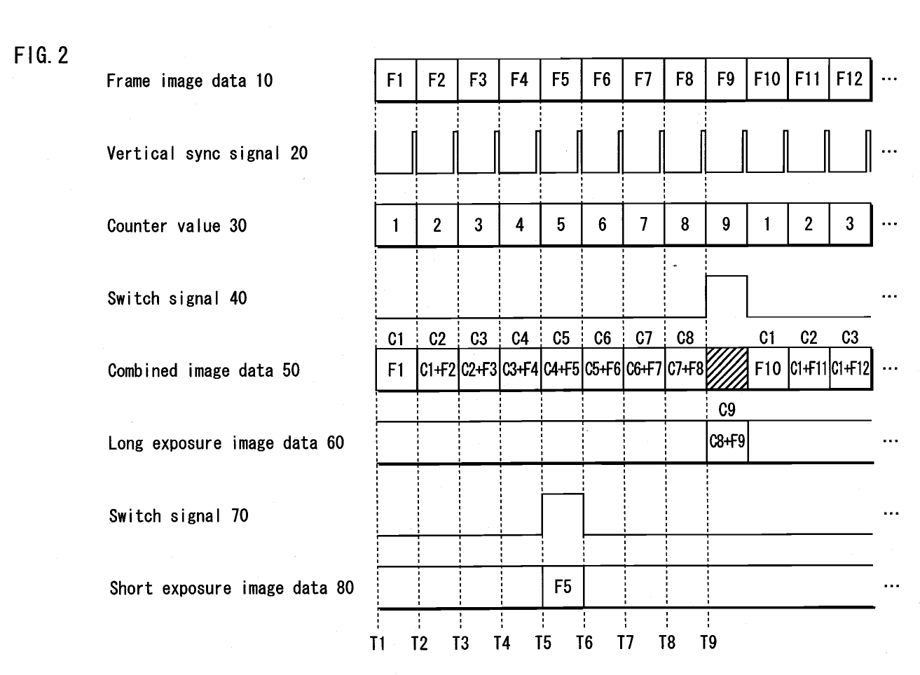

The following describes the operation of the image processing device 100 with the above-stated structure, with reference to FIG. 2.

FIG. 2 is a timing chart showing the operation of the image processing device 100.

FIG. 2 shows, as one example, a case where the imaging unit 110 performs image taking at the rate of 270 images per second, the combination number is “9”, and the selection number is “5”.

In FIG. 2, the frame image data 10 shows the frames of image data transmitted from the imaging unit 110, where “F1” to “F12” represent the first to 12^{th} frames of image data in order of transmission from the imaging unit 110 (same as image taking order). The vertical sync signal 20 shows vertical sync signals each of which is transmitted from the imaging unit 110 when a frame of image data is transmitted.

The counter value 30 shows values transmitted from the counter 131 to the comparator 141. The switch signal 40 shows a switch signal that is transmitted from the counter 131 to the switch 133 and the switch 134 when the counter 131 carries over.

The combined image data 50 shows a plurality of pieces of combined image data stored in the image storage unit 120. The long exposure image data 60 shows a piece of long exposure image data that is newly recorded into the long exposure image recording unit 150.

The switch signal 70 shows a switch signal that is transmitted from the comparator 141 to the switch 142 when the selection number set in the comparator 141 and a value of the counter 131 shown in the counter value 30 match each other. The short exposure image data 80 shows a piece of short exposure image data that is newly recorded into the short exposure image recording unit 160.

The following will describe operations to be performed at each timing.

The “T1” represents a timing at which the first frame of image data, namely “F1” in the frame image data 10, is transmitted from the imaging unit 110.

At the same timing of T1, a vertical sync signal is transmitted from the imaging unit 110 as shown in the vertical sync signal 20, and the counter value is incremented by “1” and a value “1” is transmitted from the counter 131 as shown in the counter value 30. The combiner 132 of the image combining unit 130 generates a new piece of combined image data “C1” by combining a piece of combined image data stored in the image storage unit 120 (at this timing, the image storage unit 120 has been initialized to “0” and no combined image data is stored in the image storage unit 120), with a frame of image data “F1”, and overwrites data in the image storage unit 120 with the new piece of combined image data “C1”. That is to say, at timing T1, combined image data C1 is stored in the image storage unit 120 as shown in the combined image data 50. The combined image data C1 is equivalent with frame image data “F1”.

The “T2” represents a timing at which the second frame of image data, namely “F2” in the frame image data 10, is transmitted from the imaging unit 110.

At timing T2, the counter value is incremented by “1” in the same manner as at timing T1, and a value “2” is transmitted from the counter 131 as shown in the counter value 30. The combiner 132 of the image combining unit 130 generates a new piece of combined image data “C2” by combining the combined image data C1 stored in the image storage unit 120 with the frame image data F2, and overwrites data in the image storage unit 120 with the combined image data C2. In other words, the combined image data C2 is a result of combining the frame image data F1 with the frame image data F2.

At timings T3 through T4, operations are performed in the same manner as at timing T2.

The “T5” represents a timing at which the fifth frame of image data, namely “F5” in the frame image data 10, is transmitted from the imaging unit 110.

At timing T5, a value “5” is transmitted from the counter 131 as shown in the counter value 30. The value matches the selection number “5” set in the comparator 141. As a result, the comparator 141 transmits a switch signal as shown in the switch signal 70. This activates the switch 142 so that frame image data F5 is recorded into the short exposure image recording unit 160. Namely, at timing T5, frame image data F5 is recorded into the short exposure image recording unit 160 as shown in the short exposure image data 80.

Also, at this timing of T5, the combiner 132 of the image combining unit 130 generates a new piece of combined image data “C5” by combining the combined image data C4 stored in the image storage unit 120 with the frame image data F5, and overwrites data in the image storage unit 120 with the combined image data C5. It should be noted here that the combined image data C5 is a result of combining all of the frame image data F1 through F5.

At timings T5 through T8, operations are performed in the same manner as at timing T2.

The “T9” represents a timing at which the ninth frame of image data, namely “F9” in the frame image data 10, is transmitted from the imaging unit 110.

At timing T9, a value “9”, is transmitted from the counter 131 as shown in the counter value 30. The value matches the combination number “9”. As a result, the counter 131 carries over and outputs a switch signal as shown in the switch signal 40 so that the switch 133 is activated in place of the switch 134.

Also, at this timing of T9, the combiner 132 of the image combining unit 130 generates a new piece of combined image data “C9” by combining the combined image data C8 stored in the image storage unit 120 with the frame image data F9, and overwrites data in the image storage unit 120 with the combined image data C9.

As described above, the switch 133 is activated in place of the switch 134, and thus the combined image data C9 is recorded into the long exposure image recording unit 150 as shown in the long exposure image data 60. Further, since the switch 133 is activated in place of the switch 134, the image storage unit 120 is initialized to “0”, namely, the combined image data C8 is deleted from the image storage unit 120 as shown in the combined image data 50.

At the succeeding timings, operations are performed in the same manner as at timings T1 through T9.

### <Consideration>

In the following, the effects of the image processing device 100 will be described in comparison with the effects of the imaging device 1000 of Patent Document 1.

<Effects of Image Processing Device 100>

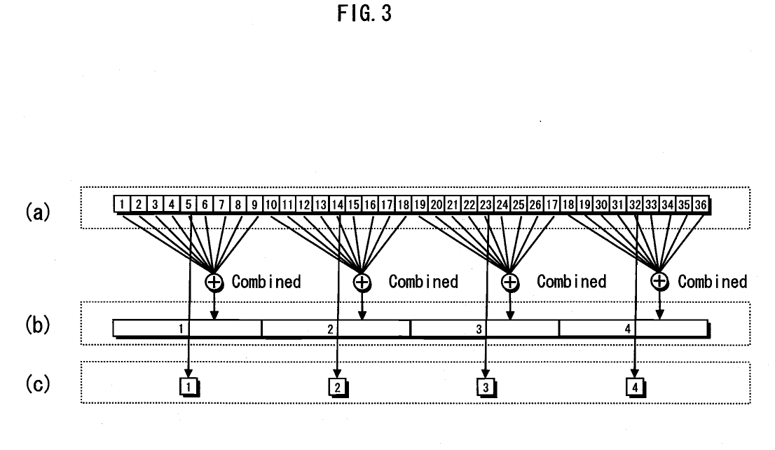

FIG. 3 illustrates relationships between the long exposure image data and the short exposure image data generated by the image processing device 100.

In FIG. 3, each rectangular box represents image data, where the size of the box corresponds to the period of exposure time or total exposure time.

FIG. 3 shows, as one example, the case of the above-described operation where the imaging unit 110 performs image taking at the rate of 270 images per second, the combination number is “9”, and the selection number is “5”.

The part (a) of FIG. 3 indicates frames of image data that are transmitted in sequence from the imaging unit 110. The numeral in each box indicates a position in the sequence of frames that are arranged in order of transmission from the imaging unit 110 (the order of image taking). In this example, the first through 36^{th} frames of image data in the sequence are shown. As mentioned above, the imaging unit 110 performs image taking at the rate of 270 images per second. Thus the exposure time of each frame of image data is 1/270 seconds.

The part (b) of FIG. 3 indicates a plurality of pieces of long exposure image data generated by the image combining unit 130. The numeral in each box indicates a position in a sequence of pieces of long exposure image data that are arranged in order of generation by the image combining unit 130. In this example, the first through 4^{th} pieces of long exposure image data in the sequence are shown. The image combining unit 130 generates each piece of long exposure image data by combining nine frames of image data, in accordance with the combination number “9”. As a result of this, each piece of long exposure image data has a total exposure time of 1/30 seconds ( 1/270 seconds×9).

The part (c) of FIG. 3 indicates a plurality of pieces of short exposure image data selected by the center frame selecting unit 140. The numeral in each box indicates a position in a sequence of pieces of short exposure image data that are arranged in order of generation by the center frame selecting unit 140. In this example, the first through 4^{th} pieces of short exposure image data in the sequence are shown. The center frame selecting unit 140 selects the fifth frame of image data from among the nine frames of image data to be combined by the image combining unit 130, in accordance with the selection number “5”. Therefore, each piece of short exposure image data has a total exposure time of 1/270 seconds that is the same as the exposure time at the image taking.

As will be understood by comparing, for example, the short exposure image data “1” shown in the part (c) of FIG. 3 with the long exposure image data “1” shown in the part (b), the period of the total exposure time of the short exposure image data is included in the total exposure time of the long exposure image data. That is to say, the image processing device 100 generates two types of sets of image data whose total exposure times are different from each other, but have the same center time, based on the frames of image data generated by one component, the imaging unit 110.

This enables moving images to be played back using the long exposure image data and the short exposure image data. When a moving image is played back at a normal rate, the playback is performed using the long exposure image data, which provides display of smooth motions. Also, the playback at the normal rate can be switched to slow playback at an arbitrary timing. In this case, the moving image playback may be switched to a playback of the short exposure image data starting with a piece of short exposure image data that corresponds (in terms of the relationships where an exposure time of apiece of short exposure image data is equivalent with an exposure time at the center of a total exposure time of a piece of long exposure image data) to a piece of long exposure image data immediately after a piece of long exposure image data at which the moving image playback stops. This produces an advantageous effect of providing moving image playback with less image blurring.

<Effects of Imaging Device 1000>

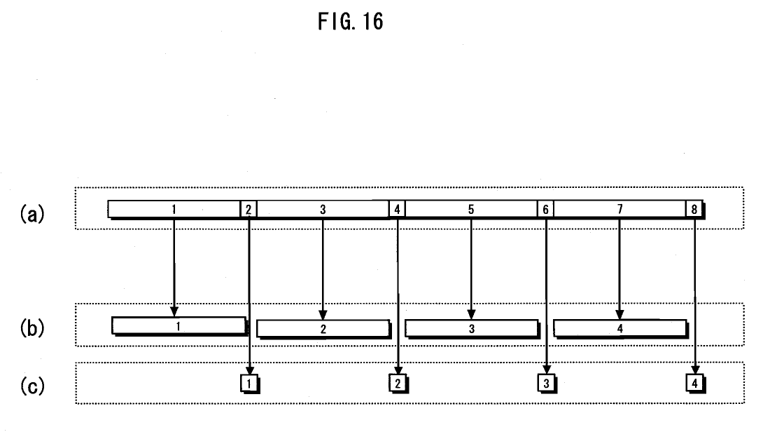

FIG. 16 illustrates relationships between the frames of image data that are generated by the imaging device 1000 with a long exposure time, and the still image data generated with a short exposure time.

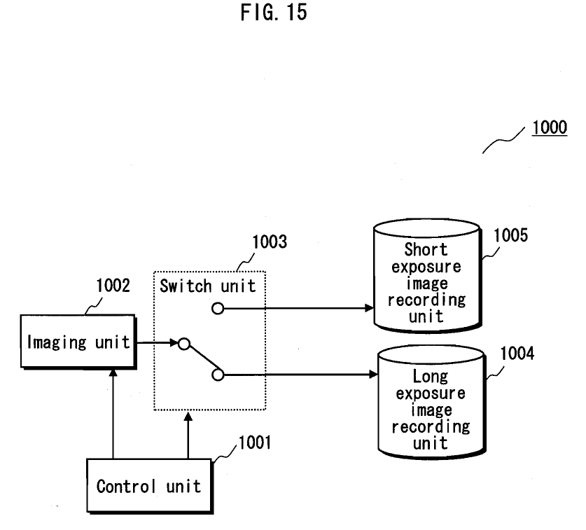

It should be noted here that the frames of image data generated with a long exposure time and the still image data generated with a short exposure time shown in FIG. 16 are based on the presumption that the imaging device 1000 of Patent Document 1 shown in FIG. 15 can take still images consecutively while it is taking the moving image. In FIG. 16, each rectangular box represents image data, where the size of the box corresponds to the period of exposure time.

The part (a) of FIG. 16 shows the frames of image data that are generated by the imaging unit 1002 of the imaging device 1000 with a long exposure time, and pieces of still image data generated with a short exposure time. The numeral in each box indicates a position in the sequence of pieces of image data that are arranged in order of transmission from the imaging unit 1002 (equivalent with the order of image taking). In this example, the image taking with a long exposure time and the image taking with a short exposure time are performed alternately.

The part (a) of FIG. 16 shows the first through eighth image data in transmission order. Among these, the first, third, fifth, and seventh image data in transmission are frames of images data that have been generated with a long exposure time (for example, 1/33.75 seconds); and the second, fourth, sixth, and eighth image data are still image data have been generated with a short exposure time (for example, 1/270 seconds).

The part (b) of FIG. 16 indicates frames of images data that have been generated with a long exposure time and are to be recorded into the long exposure image recording unit 1004 shown in FIG. 15. The part (c) of FIG. 16 indicates still image data that have been generated with a short exposure time and are to be recorded into the short exposure image recording unit 1005 shown in FIG. 15.

As will be understood by comparing, for example, the short exposure still image data “1” shown in the part (c) of FIG. 16 with the long exposure frame image data “1” shown in the part (b), the period of the exposure time of the short exposure still image data is not included in the exposure time of the long exposure frame image data. That is to say, the imaging device 1000 can generate two types of sets of image data that are different from each other in the period of exposure time. However, the two types of sets of image data generated by the imaging device 1000 do not overlap with each other in the period of exposure time (period of image taking), while the two types of sets of image data generated by the image processing device 100 of the present embodiment overlap with each other in the period of exposure time (period of image taking).

Accordingly, the imaging device 1000 of Patent Document 1 cannot produce the advantageous effects that are produced by the image processing device 100 of the present embodiment.

### <Modification 1>

In Embodiment 1, the imaging unit 110 of the image processing device 100 generates frames of image data in sequence with a predetermined exposure time in accordance with an instruction from the control unit 170.

Described in the following is a modification where the imaging unit 110 is replaced with a unit that can generate frames of image data with different exposure times.

The imaging unit of the image processing device in Modification 1 is the same as the imaging unit 110 of the image processing device 100 in Embodiment 1, except that it can generate frames of image data with two exposure times. Also, the control unit of the image processing device in Modification 1 is the same as the control unit 170 of the image processing device 100 in Embodiment 1, except that it controls the imaging unit to generate frames of image data with two exposure times.

The following will describe advantageous effects produced by the image processing device of Modification 1.

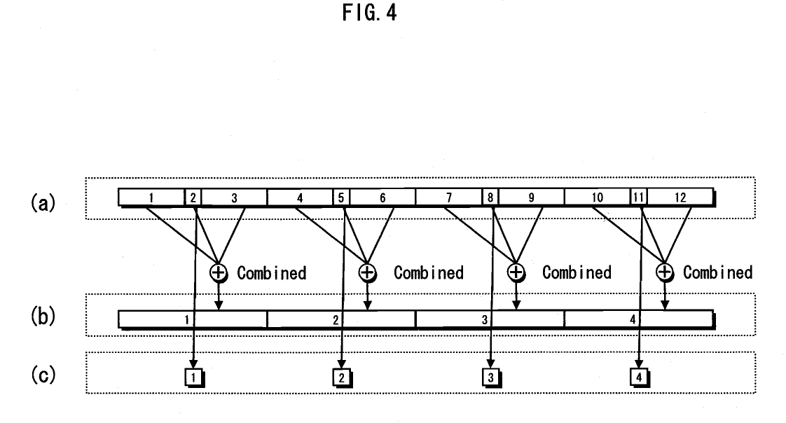

FIG. 4 illustrates relationships between the long exposure image data and the short exposure image data generated by the image processing device of Modification 1. In FIG. 4, as is the case with FIG. 3, each rectangular box represents image data, where the size of the box corresponds to the period of exposure time or total exposure time.

FIG. 4 shows, as one example, the case where the imaging unit of the image processing device in Modification 1 performs image taking with an exposure time of 1/67.5 seconds (hereinafter referred to as “exposure time A”) and with an exposure time of 1/270 seconds (hereinafter referred to as “exposure time B”), the combination number is “3”, and the selection number is “2”.

The part (a) of FIG. 4 indicates frames of image data that are transmitted in sequence from the imaging unit. The numeral in each box indicates a position in the sequence of frames that are arranged in order of transmission from the imaging unit (the order of image taking). In this example, the first through 12^{th} frames of image data in the sequence are shown of these, the first, third, fourth, sixth, seventh, ninth, 10^{th}, and 12^{th} frames of image data in transmission are frames of images data that have been generated with the exposure time A, and the others are frames of images data that have been generated with the exposure time B.

The part (b) of FIG. 4 indicates a plurality of pieces of long exposure image data generated by the image combining unit 130. The numeral in each box indicates a position in a sequence of pieces of long exposure image data that are arranged in order of generation by the image combining unit 130. In this example, the first through 4^{th} pieces of long exposure image data in the sequence are shown. The image combining unit 130 generates each piece of long exposure image data by combining three frames of image data, in accordance with the combination number “3”. As a result of this, each piece of long exposure image data has a total exposure time of 1/30 seconds ( 1/67.5 seconds×2+ 1/270 seconds).

The part (c) of FIG. 4 indicates a plurality of pieces of short exposure image data selected by the center frame selecting unit 140. The numeral in each box indicates a position in a sequence of pieces of short exposure image data that are arranged in order of generation by the center frame selecting unit 140. In this example, the first through 4^{th} pieces of short exposure image data in the sequence are shown. The center frame selecting unit 140 selects the second frame of image data from among the three frames of image data to be combined by the image combining unit 130, in accordance with the selection number “2”. Therefore, each piece of short exposure image data has a total exposure time of 1/270 seconds that is the same as the exposure time B at the image taking.

As described above, the image combining unit 130 of the image processing device in Modification 1 can obtain long exposure image data with a total exposure time of 1/30 seconds as is the case with the image processing device 100 in Embodiment 1, with less combination number (“3”) than combination number (“9”) of the image combining unit 130 of the image processing device 100 in Embodiment 1. That is to say, with this modification, it is possible to reduce the number of calculations required for combining the image data.

### Embodiment 2

### <Overview>

The image processing device of Embodiment 2 is an improvement of a conventional image processing device (moving image encoding device) that supports the MPEG-4 AVC (Moving Picture Expert Group-4 Advanced Video Coding) standard, and generates a plurality of encoded data sequences in the format of MPEG-4 AVC by compress encoding a plurality of sets of image data.

More specifically, the image processing device of Embodiment 2 compress encodes the long exposure image data and the short exposure image data generated by the image processing device 100 of Embodiment 1 as follows: the image processing device of Embodiment 2 detects motion vectors of each piece of short exposure image data, and compress encodes each piece of short exposure image data and corresponding pieces of long exposure image data using the detected motion vectors.

That is to say, the conventional image processing device detects motion vectors from the long exposure image data and the short exposure image data, respectively. In contrast, the image processing device of Embodiment 2 does not detect motion vectors from the long exposure image data, but compress encodes the long exposure image data using the motion vectors detected from the short exposure image data.

Namely, the image processing device of Embodiment 2 can reduce the amount of process of the compress encoding, compared with the conventional image processing device, as much as the amount of processing required to detect motion vectors from the long exposure image data, which is not performed in Embodiment 2.

Further, although the motion vectors detected from the short exposure image data are shared, the compression rate of each piece of long exposure image data can be maintained. The reasons are explained in the following.

As explained in Embodiment 1, the corresponding pieces of the long and short exposure image data match each other in the exposure time at the center of the total exposure time, thus there is a high possibility that the corresponding pieces of the long and short exposure image data represent images that resemble each other. That is to say, high is the level of match between motion vectors respectively obtained from the corresponding pieces of long and short exposure image data.

It is therefore possible to maintain the compression rate of each piece of long exposure image data, by compress encoding the long exposure image data using the motion vectors detected from the short exposure image data.

### <Structure>

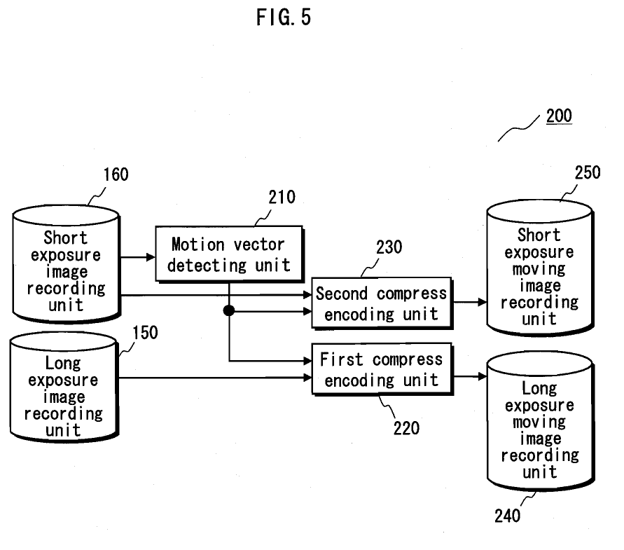

FIG. 5 is a functional block diagram of an image processing device 200 in Embodiment 2 of the present invention.

As shown in FIG. 5, the image processing device 200 includes a long exposure image recording unit 150, a short exposure image recording unit 160, a motion vector detecting unit 210, a first compress encoding unit 220, a second compress encoding unit 230, a long exposure moving image recording unit 240, and a short exposure moving image recording unit 250.

Here, the long exposure image recording unit 150 and the short exposure image recording unit 160 are the same as those of the image processing device 100 in Embodiment 1. Namely, the long exposure image recording unit 150 stores the generated long exposure image data, and the short exposure image recording unit 160 stores the short exposure image data.

The motion vector detecting unit 210 has a function to detect motion vectors in units of macro blocks of a predetermined size (for example, 16×16 pixels), from each piece of short exposure image data (having a size of, for example, 640×480 pixels) stored in the short exposure image recording unit 160. In this detection of motion vectors, motion vectors with higher accuracy can be obtained since the short exposure image data represents clear images with less blurring.

The process of motion vector detection will be described in detail, where a piece of short exposure image data that is the target of the process is referred to as “process target image”, a macro block that is the target of the process is referred to as “process target block”, and a piece of short exposure image data that is before or after the process target image in order of generation by the center frame selecting unit 140 is referred to as “reference image”. First, the motion vector detecting unit 210 performs a block matching to detect a macro block that resembles most to the process target block, from the reference image. Second, the motion vector detecting unit 210 obtains a motion vector that indicates a relative position of the detected macro block to the process target block. In the following description, it is presumed that the reference image is a piece of short exposure image data that is before the process target image in order of generation by the center frame selecting unit 140.

Upon detecting motion vectors, the motion vector detecting unit 210 transmits the detected motion vectors to the first compress encoding unit 220 and the second compress encoding unit 230.

The second compress encoding unit 230 encodes the process target image recorded in the short exposure image recording unit 160, based on the motion vectors received from the motion vector detecting unit 210. More specifically, the second compress encoding unit 230 generates a predicted image of the process target image based on the received motion vectors, obtains difference data between the predicted image and the process target image (original image), encodes the difference data and the motion vectors to obtain an encoded data sequence in the format of MPEG-4 AVC, and records the obtained encoded data sequence into the short exposure moving image recording unit 250.

In the above-description, the second compress encoding unit 230 performs encoding by what is called inter encoding method. However, not limited to this, the encoding may be performed by what is called intra encoding method where the encoding is performed without referring to another image if the target image satisfies a predetermined condition such as a predetermined cycle.

The first compress encoding unit 220 basically has the same function as the second compress encoding unit 230, except that it encodes each piece of long exposure image data stored in the long exposure image recording unit 150.

More specifically, the first compress encoding unit 220 generates a predicted image of a piece of long exposure image data corresponding to the process target image (short exposure image data), based on the motion vectors received from the motion vector detecting unit 210, obtains difference data between the predicted image and the piece of long exposure image data (original image), encodes the difference data and the motion vectors to obtain an encoded data sequence in the format of MPEG-4 AVC, and records the obtained encoded data sequence into the long exposure moving image recording unit 240.

The first compress encoding unit 220, as is the case with the second compress encoding unit 230, may perform encoding by what is called intra encoding method, as well as what is called inter encoding method.

Each of the long exposure moving image recording unit 240 and the short exposure moving image recording unit 250 is achieved by a recording medium such as a memory or a hard disk. The long exposure moving image recording unit 240 has a function to store encoded data sequences in the MPEG-4 AVC format generated by the first compress encoding unit 220 from corresponding pieces of long exposure image data. The short exposure moving image recording unit 250 has a function to store encoded data sequences in the MPEG-4 AVC format generated by the second compress encoding unit 230 from corresponding pieces of short exposure image data. It should be noted here that the long exposure moving image recording unit 240 and the short exposure moving image recording unit 250 may be physically achieved by one memory, one hard disk or the like, or may be achieved by one memory, one hard disk or the like together with the long exposure image recording unit 150 and the short exposure image recording unit 160.

### <Operation>

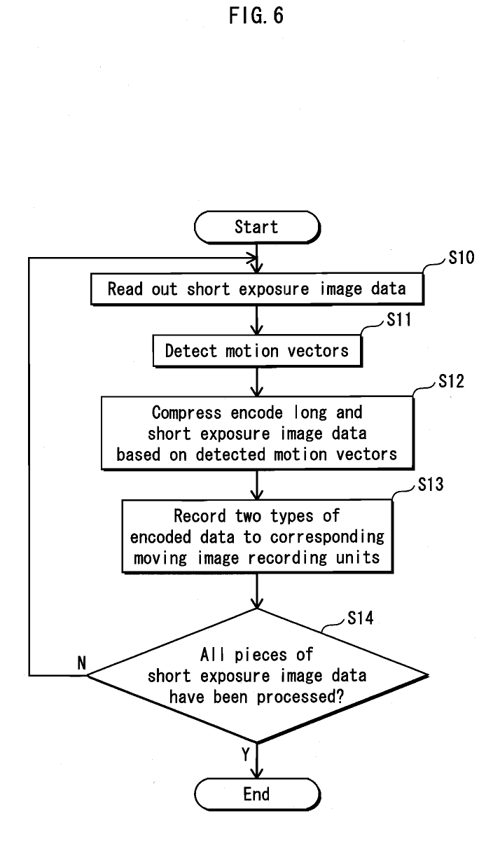

The following describes the operation of the image processing device 200 with the above-stated structure, with reference to FIG. 6.

FIG. 6 is a flowchart showing the operation of the image processing device 200.

The motion vector detecting unit 210 reads out a piece of short exposure image data from the short exposure image recording unit 160 (step S10).

The motion vector detecting unit 210 detects motion vectors in units of macro blocks, from the process target image (the read-out piece of short exposure image data) in comparison with the reference image (a piece of short exposure image data that is before the process target image in order of generation by the center frame selecting unit 140) (step S11), and transmits the detected motion vectors to the first compress encoding unit 220 and the second compress encoding unit 230.

The second compress encoding unit 230 reads out a process target image (a piece of short exposure image data) from the short exposure image recording unit 160. The first compress encoding unit 220 reads out a piece of long exposure image data corresponding to the process target image (piece of short exposure image data), from the long exposure image recording unit 150. The second compress encoding unit 230 generates a predicted image of the process target image based on motion vectors received from the motion vector detecting unit 210, obtains difference data between the predicted image and the process target image (original image), and encodes the difference data. Also, the first compress encoding unit 220 generates a predicted image of the read-out piece of long exposure image data, based on the motion vectors received from the motion vector detecting unit 210, obtains difference data between the predicted image and the piece of long exposure image data (original image), and encodes the difference data (step S12).

The second compress encoding unit 230 records the generated encoded data sequence into the short exposure moving image recording unit 250, and the first compress encoding unit 220 records the generated encoded data sequence into the long exposure moving image recording unit 240 (step S13).

The motion vector detecting unit 210 returns to step S10 when not all pieces of short exposure image data have been processed (“N” in step S14), and ends the process when all pieces of short exposure image data have been processed (“Y” in step S14).

### <Consideration>

Here will be described the compression rate of the image data in the image processing device 200.

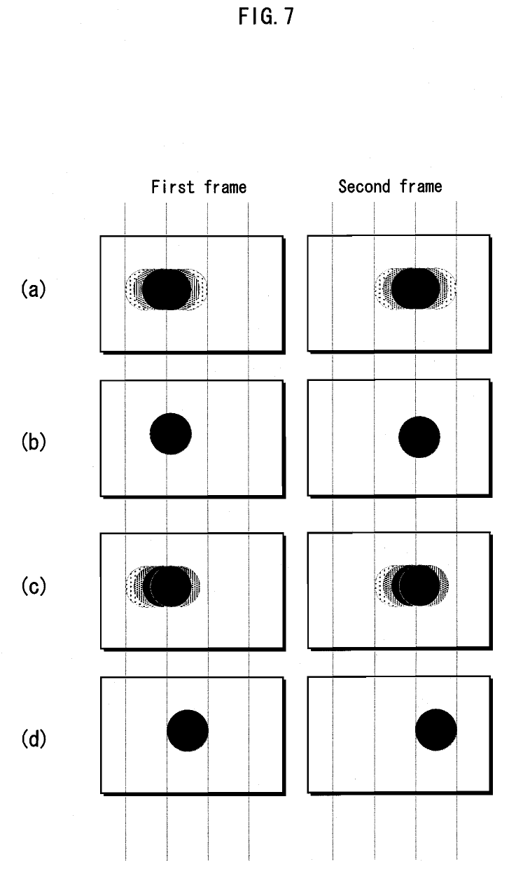

FIG. 7 shows image data sequences that are respectively obtained by the image processing device 100 of Embodiment 1 and the imaging device 1000 in Patent Document 1 when they take images of the same object.

In the present example, it is presumed that a spherical object moving from left to right is taken as an image. It is also presumed, as is the case with FIG. 16, that the imaging device 1000 of Patent Document 1 can take still images consecutively while it is taking a moving image.

The part (a) of FIG. 7 shows two pieces of long exposure image data that are consecutive in order of generation and are stored in the long exposure image recording unit 150 of the image processing device 100 in Embodiment 1. In this example, the object in each piece of long exposure image data blurs horizontally since each piece of long exposure image data is a combination of a plurality of frames of image data that are generated by taking a moving spherical object in sequence.

The part (b) of FIG. 7 shows two pieces of short exposure image data that are stored in the short exposure image recording unit 160 of the image processing device 100 in Embodiment 1. Each of the two pieces of short exposure image data is positioned at the center of a sequence of frames of image data that are arranged in order of transmission from the imaging unit 110 (equivalent with the order of image taking) and are combined together to form a corresponding piece of long exposure image data shown in the part (a) of FIG. 7.

The corresponding frames in the parts (a) and (b) of FIG. 7 match each other in the exposure time at the center of the total exposure time. In the circumstances, the level of match between two motion vectors obtained is high, where one of the two motion vectors is obtained as a motion vector of the long exposure image data of the second frame in the part (a) of FIG. 7, using the long exposure image data of the first frame in the part (a) as the reference image, and the other of the two motion vectors is obtained as a motion vector of the short exposure image data of the second frame in the part (b) of FIG. 7, using the short exposure image data of the first frame in the part (b) as the reference image.

The part (c) of FIG. 7 shows two frames of image data that were taken with a long exposure time and are stored in the long exposure image recording unit 1004 of the imaging device 1000 of Patent Document 1.

The part (d) of FIG. 7 shows two pieces of still image data that were taken with a short exposure time and are stored in the short exposure image recording unit 1005 of the imaging device 1000 of Patent Document 1, where each piece of still image data shown in the part (d) of FIG. 7 was taken immediately after a corresponding frame of image data shown in the part (c) of FIG. 7 was taken with a long exposure time. Accordingly, the exposure time period of a frame of image data shown in the part (c) of FIG. 7 never matches the exposure time period of a corresponding piece of still image data shown in the part (c) of FIG. 7. Namely, the corresponding image data in the parts (c) and (d) of FIG. 7 do not match each other in the exposure time at the center of the exposure time. As a result, the level of match between two motion vectors obtained from the parts (c) and (d) of FIG. 7 is lower than the level of match obtained from the parts (a) and (b) of FIG. 7 as described above, where one of the two motion vectors is obtained as a motion vector of the frame image data of the second frame in the part (c) of FIG. 7, using the frame image data of the first frame in the part (c) as the reference image, and the other of the two motion vectors is obtained as a motion vector of the still image data of the second frame in the part (d) of FIG. 7, using the still image data of the first frame in the part (d) as the reference image.

As described above, high is the level of match between motion vectors of the long and short exposure image data generated by the image processing device 100 in Embodiment 1. It is therefore possible to use motion vectors detected from the short exposure image data, to compress encode the corresponding long exposure image data. In this case, the compression rate of each piece of long exposure image data is maintained. Also, the amount of process for the compress encoding is reduced since the motion vector is not detected from the long exposure image data.

### Embodiment 3

### <Overview>

The image processing device of Embodiment 3 is an improvement of a conventional image processing device (playback device) that plays back encoded data sequences in the MPEG-4 AVC format, and can perform playback at different playback speeds by switching between different types of encoded data sequences to be read out for the playback, namely by switching between encoded long exposure image data sequences and encoded short exposure image data sequences, which are both in the MPEG-4 AVC format and are generated by the image processing device 200 in Embodiment 2.

More specifically, to playback at a normal rate, the image processing device of Embodiment 3 reads out encoded long exposure image data in sequence in order of playback from the encoded data sequences in the MPEG-4 AVC format so that the decoded long exposure image data are displayed in sequence. This enables the moving image to be displayed smoothly.

Further, upon receiving, from the user, a playback speed switch instruction (for example, an instruction to change to a slow playback) during a playback at a normal rate, the image processing device of Embodiment 3 reads out encoded short exposure image data in sequence in order of playback starting with a piece of encoded short exposure image data that corresponds to a piece of long exposure image data immediately after a piece of long exposure image data at which the normal playback stops, from the encoded data sequences in the MPEG-4 AVC format, and decodes the read-out data in sequence so that the decoded data is displayed at a playback speed specified by the user (slow). This enables a clear, less-blurred image to be displayed.

In this way, the image processing device of Embodiment 3 can switch between frames of image data to display, depending on the specified playback speed, namely can switch between the long exposure image data and the short exposure image data, and thus can provide a clear display when a playback is performed at either of the playback speeds.

### <Structure>

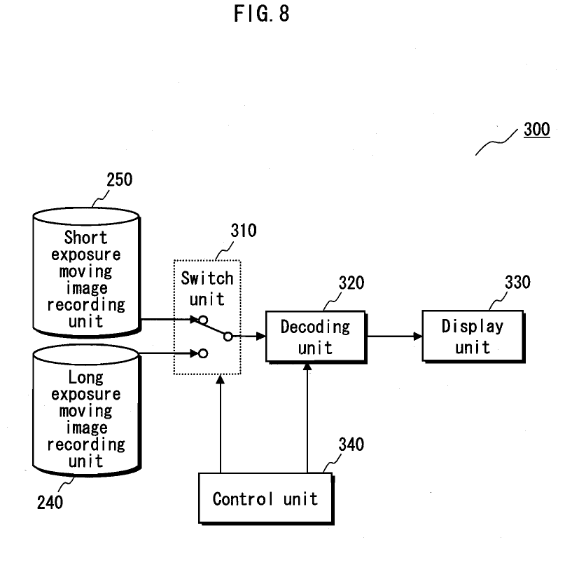

FIG. 8 is a functional block diagram of an image processing device 300 in Embodiment 3 of the present invention.

As shown in FIG. 8, the image processing device 300 includes a long exposure moving image recording unit 240, a short exposure moving image recording unit 250, a switch unit 310, a decoding unit 320, a display unit 330, and a control unit 340.

Here, the long exposure moving image recording unit 240 and the short exposure moving image recording unit 250 are the same as those of the image processing device 200 in Embodiment 2. Namely, the long exposure moving image recording unit 240 stores encoded data sequences in the MPEG-4 AVC format generated from corresponding pieces of long exposure image data. The short exposure moving image recording unit 250 stores encoded data sequences in the MPEG-4 AVC format generated from corresponding pieces of short exposure image data.

The switch unit 310 has a function to, in accordance with the control by the control unit 340, switch between the long exposure moving image recording unit 240 and the short exposure moving image recording unit 250 as destinations to which frames of image data are read.

The decoding unit 320 has a function to read data, that is necessary to decode the encoded frames of image data in order of playback at a decoding speed specified by the control unit 340, from the encoded data sequences in the MPEG-4 AVC format stored in the long exposure moving image recording unit 240 or the short exposure moving image recording unit 250, and to transmit the decoded frames of image data to the display unit 330. Specific description of the decoding by the decoding unit 320 is omitted since it is the same as conventional ones used in image processing devices to decode encoded data sequences in the MPEG-4 AVC format. It should be noted, however, that information indicating the order of playback is included in the encoded data sequences in the MPEG-4 AVC format, and the order of playback of the encoded image frames is determined by referring to the information.

The display unit 330 includes a Liquid Crystal Display (LCD), and each time it receives a decoded frame of image data from the decoding unit 320, it display the received frame of image data.

The control unit 340 includes a processor and a memory (that are not illustrated), and has a function to control the switch unit 310 and the decoding unit 320 in accordance with an instruction that is received from the user via an operation unit (not illustrated). The function of the control unit 340 is achieved in a software-like manner when the processor executes a control program stored in the memory.

More specifically, upon receiving a playback instruction or a playback speed switch instruction from the user, when the playback speed specified in the instruction is equal to or higher than a predetermined threshold value (for example, a value indicating a normal rate), the control unit 340 causes the switch unit 310 to connect to the long exposure moving image recording unit 240, and when the playback speed specified in the instruction is lower than the predetermined threshold value, the control unit 340 causes the switch unit 310 to connect to the short exposure moving image recording unit 250. The control unit 340 also controls the decoding unit 320 to decode at a decoding speed in correspondence with the playback speed specified by the user.

When it receives a stop instruction from the user via an operation unit, the control unit 340 performs a control to cause the decoding unit 320 to stop decoding, so that the playback process is ended.

### <Operation>

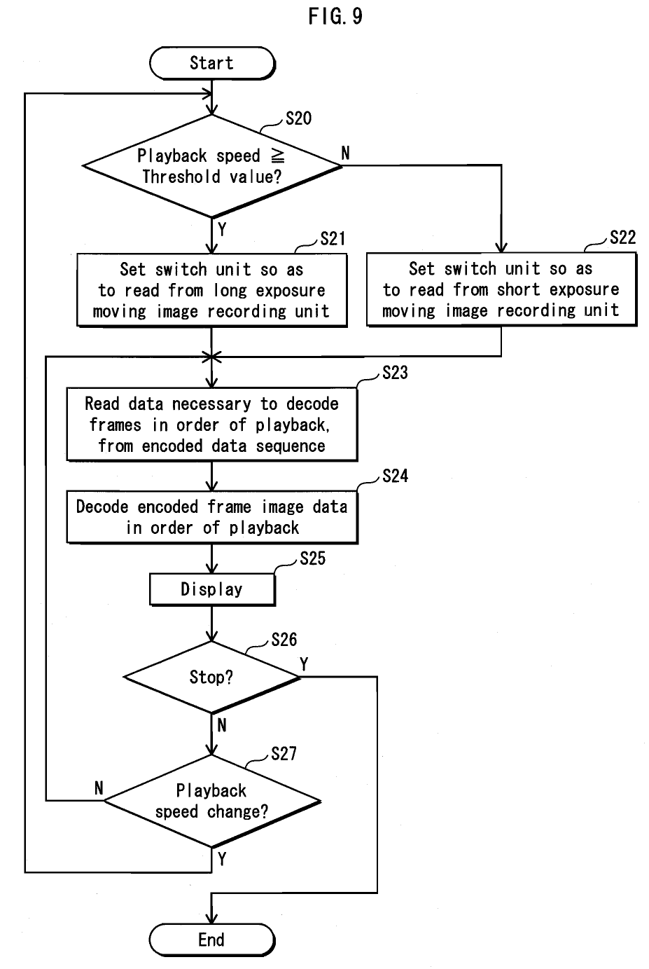

The following describes the operation of the image processing device 300 with the above-stated structure, with reference to FIG. 9.

FIG. 9 is a flowchart showing the operation of the image processing device 300.

The control unit 340 judges whether or not the playback speed that is specified in a playback instruction received from the user via an operation unit (not illustrated) is equal to or higher than a predetermined threshold value (step S20).

When it judges that the playback speed is equal to or higher than the predetermined threshold value (“Y” in step S20), the control unit 340 causes the switch unit 310 to connect to the long exposure moving image recording unit 240 (step S21).

When it judges that the playback speed is lower than the predetermined threshold value (“N” in step S20), the control unit 340 causes the switch unit 310 to connect to the short exposure moving image recording unit 250 (step S22).

The decoding unit 320 reads data, that is necessary to decode the encoded frames of image data in order of playback, from the encoded data sequences in the MPEG-4 AVC format stored in the long exposure moving image recording unit 240 or the short exposure moving image recording unit 250, depending on the setting to the switch unit 310 (step S23). In this step, the seek operation is performed as necessary. That is to say, when, in step S27 that will be described later, a playback speed change instruction is received (“Y” in step S27), there may be a case where there is no need to play back starting with the first frame in order of playback. In that case, the seek operation is performed to read out the data that is necessary to decode the frame corresponding to the appropriate order of playback.

The decoding unit 320 decodes encoded frames of image data in order of playback, based on the data read out in step S23, at a decoding speed specified by the control unit 340 (step S24).

The decoding unit 320 transmits the decoded frames of image data to the display unit 330. The display unit 330 displays the frames of images based on the received data (step S25).

The control unit 340 judges whether or not a stop instruction has been received from the user via the operation unit (step S26). When it judges that the stop instruction has been received (“Y” in step S26), the control unit 340 ends the playback process. When it judges that the stop instruction has not been received (“N” in step S26), the control unit 340 judges whether or not a playback speed change instruction has been received from the user via the operation unit (step S27).

When it judges that the playback speed change instruction has not been received (“N” in step S27), the control unit 340 returns to step S23 to continue the process. When it judges that the playback speed change instruction has been received (“Y” in step S27), the control unit 340 returns to step S20 to continue the process.

With this structure, when, for example, the predetermined threshold value has been set to a value indicating a normal rate, and when the control unit 340 receives, from the user, a playback instruction to play back at the normal rate, the decoding unit 320 reads out encoded long exposure image data in sequence in order of playback from the encoded data sequences in the MPEG-4 AVC format stored in the long exposure moving image recording unit 240, and decodes the read-out data, so that the decoded data is displayed.

Also, when the control unit 340 receives, from the user, a playback speed change instruction (namely, an instruction to change to a slow playback or to a pause) during a playback at a normal rate, the decoding unit 320 reads out a piece of encoded short exposure image data that corresponds to a piece of long exposure image data immediately after a frame of image data (a piece of long exposure image data) at which the normal playback stops, from the encoded data sequences in the MPEG-4 AVC format stored in the short exposure moving image recording unit 250, and decodes the read-out data, so that the decoded data is displayed.

It should be noted here that when the playback speed change instruction received from the user is a pause instruction, the decoded piece of short exposure image data is kept to be displayed until a playback speed change instruction (namely, an instruction to change to a slow playback or to a playback at the normal rate) is received.

On the other hand, in the case of the slow playback, the decoding unit 320 continues to read out pieces of encoded short exposure image data in sequence in order of playback from the encoded data sequences in the MPEG-4 AVC format stored in the short exposure moving image recording unit 250, and decode the read-out data so that the decoded data is displayed, until the control unit 340 receives an instruction to change to a playback at a rate higher than the threshold value, such as an instruction to change to a playback at the normal rate.

Accordingly, with the image processing device 300 of the present embodiment, the user only needs to specify the playback speed as conventionally but does not need to perform any special operation to enjoy smooth moving image display in the playback at the normal rate in which used are encoded long exposure image data sequences in the MPEG-4 AVC format stored in the long exposure moving image recording unit 240, and to enjoy clear image display in the slow playback or pause in which used are encoded short exposure image data sequences in the MPEG-4 AVC format stored in the short exposure moving image recording unit 250.

The image processing device 300 of the present embodiment enables a clear, less-blurred image to be displayed during a slow playback or pause, and thus is suitable for editing moving images or printing the screen during a pause.

### Embodiment 4

### <Overview>

The image processing device of Embodiment 4 generates encoded data sequences in the MPEG-4 AVC format, as is the case with the image processing device 200 of Embodiment 2, but by a method that is different from the method used by the image processing device 200.

More specifically, the image processing device of Embodiment 4 compress encodes each piece of long exposure image data as is the case with the image processing device 200, generates difference data that shows difference between the short exposure image data and the corresponding long exposure image data, encodes the difference data, and generates encoded data sequences in the MPEG-4 AVC format using the generated pieces of data.

The long exposure image data and the short exposure image data corresponding to each other resemble each other, and thus the amount of the difference data between these data is small. Therefore, the image processing device 400 in Embodiment 4 is expected to improve the recording efficiency of the encoded data sequences.

### <Structure>

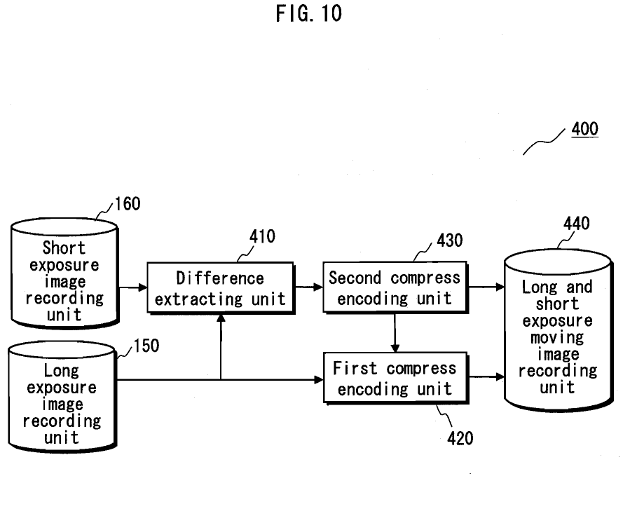

FIG. 10 is a functional block diagram of an image processing device 400 in Embodiment 4 of the present invention.

As shown in FIG. 10, the image processing device 400 includes a long exposure image recording unit 150, a short exposure image recording unit 160, a difference extracting unit 410, a first compress encoding unit 420, a second compress encoding unit 430, and a long and short exposure moving image recording unit 440.

Here, the long exposure image recording unit 150 and the short exposure image recording unit 160 are the same as those of the image processing device 100 in Embodiment 1. Namely, the long exposure image recording unit 150 stores the generated long exposure image data, and the short exposure image recording unit 160 stores the short exposure image data.

The difference extracting unit 410 has a function to generate difference data that shows difference between the short exposure image data stored in the short exposure image recording unit 160 and the corresponding long exposure image data recorded in the long exposure image recording unit 150.

It should be noted here that the difference data is obtained by performing, for all pixels constituting one frame of image data, the process of subtracting a pixel value of a piece of long exposure image data from a pixel value of a corresponding piece of short exposure image data, with respect to the same pixel position.

Before generating the difference data, the difference extracting unit 410 performs the process of dividing each pixel value of each piece of long exposure image data, which is used in the generation of the difference data, by the combination number (“9” in Embodiment 1). After this process, the long exposure image data matches the short exposure image data in the grayscale (brightness) bit value.

The difference extracting unit 410 transmits the generated difference data to the second compress encoding unit 430.

The second compress encoding unit 430 has a function to encode the difference data received from the difference extracting unit 410, by a predetermined encoding method such as the variable length encoding method, and records the encoded difference data into the long and short exposure moving image recording unit 440 to be used as part of encoded data sequences in the MPEG-4 AVC format as will be described later. The second compress encoding unit 430 performs this function in close coordination with the first compress encoding unit 420 with regards to the recording areas in the long and short exposure moving image recording unit 440 and the like.

The first compress encoding unit 420 has a function to encode the long exposure image data recorded in the long exposure image recording unit 150 by a method conforming to the MPEG-4 AVC standard (for example, what is called intra encoding method or what is called inter encoding method), and records pieces of encoded long exposure image data into the long and short exposure moving image recording unit 440 as encoded data sequences in the MPEG-4 AVC format.

Some formats including the MPEG-4 AVC format for the encoded data sequences define a header for storing information unique to the user. By using the definition of the header, it is possible to allocate a user extended header area (hereinafter, merely referred to as “extended area”) to each picture. The extended area is permitted to store, for example, data that was created uniquely by a maker.

Using this system, the first compress encoding unit 420 generates encoded long exposure image data sequences in the MPEG-4 AVC format, with the encoded difference data (each piece of which is generated by encoding a piece of difference data that was generated using a corresponding piece of long exposure image data before being encoded) being embedded in the extended areas thereof, where the encoded difference data has been recorded into the long and short exposure moving image recording unit 440 by the second compress encoding unit 430. The first compress encoding unit 420 records the generated encoded long exposure image data sequences into the long and short exposure moving image recording unit 440. The structure of the encoded data sequences in the MPEG-4 AVC format will be described later.

Even when the encoded data sequences in the MPEG-4 AVC format are played back by a conventional image processing device, the playback is based on only the long exposure image data, and the contents of the extended area is disregarded. Accordingly, the encoded data sequences in the MPEG-4 AVC format generated in the present embodiment have compatibility.

The long and short exposure moving image recording unit 440 is achieved by a recording medium such as a memory or a hard disk. The long and short exposure moving image recording unit 440 has a function to store the encoded data sequences in the MPEG-4 AVC format generated by the second compress encoding unit 430 and the first compress encoding unit 420. The long and short exposure moving image recording unit 440 may be achieved by one memory, one hard disk or the like together with the long exposure image recording unit 150 and the short exposure image recording unit 160.

### <Data>

The following will briefly describe the encoded data sequences in the MPEG-4 AVC format to be recorded in the long and short exposure moving image recording unit 440.

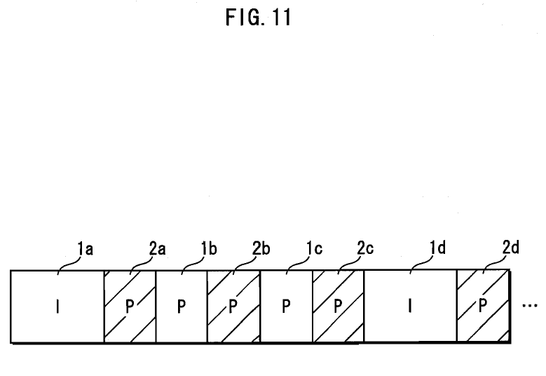

FIG. 11 illustrates the structure of an encoded data sequence in the MPEG-4 AVC format to be recorded in the long and short exposure moving image recording unit 440.

As shown in FIG. 11, the encoded data sequence in the MPEG-4 AVC format includes encoded long exposure image data 1a, 1b, 1c and 1d and encoded difference data 2a, 2b, 2c and 2d. Each piece of encoded difference data is recorded in the extended area defined in the MPEG-4 AVC standard.

In this example shown in FIG. 11, the encoded long exposure image data 1a and 1d are I-slices, and the encoded long exposure image data 1b and 1c are P-slices.

The encoded difference data 2a indicates a difference between a piece of long exposure image data, which is encoded to be the encoded long exposure image data 1a, and a corresponding piece of short exposure image data. The encoded difference data 2b, 2c and 2d correspond to the encoded long exposure image data 1b, 1c and 1d in the same manner, respectively.

As described above, stored in the extended area of a piece of encoded long exposure image data is a piece of encoded difference data that was generated using a piece of long exposure image data which is encoded to be the piece of encoded long exposure image data. Accordingly, when an encoded data sequence in the MPEG-4 AVC format is played back, it is possible to display the frames of image data by switching between the long exposure image data and the short exposure image data that has been decoded using the long exposure image data and the difference data. This will be described in detail in Embodiment 5.

### <Operation>

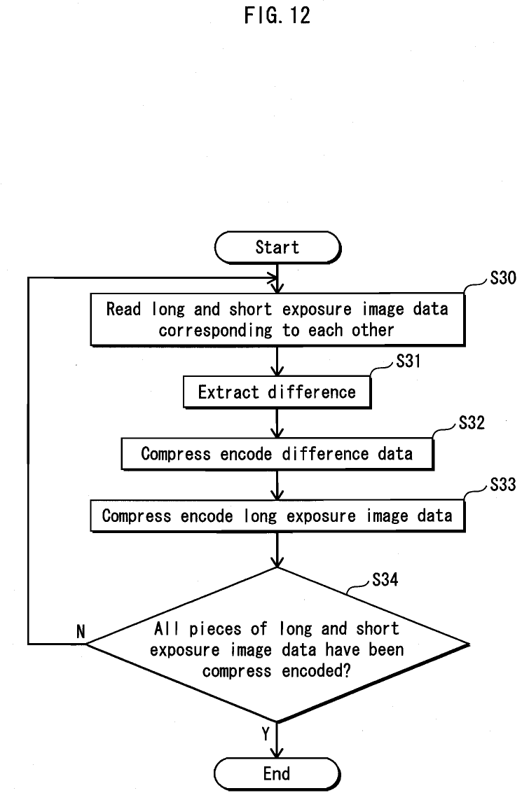

The following describes the operation of the image processing device 400 with the above-stated structure, with reference to FIG. 12.

FIG. 12 is a flowchart showing the operation of the image processing device 400.

The difference extracting unit 410 reads out pieces of the long and short exposure image data corresponding to each other, in order of generation from the long exposure image recording unit 150 and the short exposure image recording unit 160 (step S30).

The difference extracting unit 410 generates difference data indicating difference between the read-out pieces of the long and short exposure image data, and transmits the generated difference data to the second compress encoding unit 430 (step S31).

The second compress encoding unit 430 encodes the difference data received from the difference extracting unit 410 by the variable length encoding method, and records the encoded difference data into the long and short exposure moving image recording unit 440 to be used as part of encoded data sequences in the MPEG-4 AVC format (step S32).

The first compress encoding unit 420 generates an encoded long exposure image data sequence by encoding the long exposure image data read out by the difference extracting unit 410 in step S30, by a method conforming to the MPEG-4 AVC standard. Also, the first compress encoding unit 420 generates the encoded long exposure image data sequence in the MPEG-4 AVC format, with the encoded difference data, which was recorded by the second compress encoding unit 430 in step S32, being embedded in the extended area thereof, and records the generated encoded long exposure image data sequence (step S33).

When all pieces of long and short exposure image data have not been compress encoded (“N” in step S34), the control returns to step S30; and when all pieces of long and short exposure image data have been compress encoded (“Y” in step S34), the compress encoding process ends.

### <Modification 2>

Each encoded data sequence in Embodiment 4 is recorded into the long and short exposure moving image recording unit 440 as one encoded data sequence generated by combining the long and short exposure moving image data. However, not limited to this, encoded data sequences of long exposure moving image data and encoded data sequences of short exposure moving image data may be recorded into different recording mediums, respectively.

In this case, the first compress encoding unit 420 may store a pointer in the extended area of the generated encoded data sequence, the pointer pointing to a corresponding frame position in the encoded data sequence generated by the second compress encoding unit 430. With this structure, it is possible to hold the correspondence between two types of encoded data sequences that are recorded in different recording mediums.

### Embodiment 5

### <Overview>

The image processing device of Embodiment 5, as is the case with the image processing device 300 in Embodiment 3, can perform playback at different playback speeds by switching between the long exposure image data and the short exposure image data in order of playback. The image processing device of Embodiment 5 is different from the image processing device 300 in Embodiment 3 in that it performs playback using the encoded data sequences in the MPEG-4 AVC format generated by the image processing device 400 in Embodiment 4.

More specifically, the image processing device of Embodiment 5 reads out encoded long exposure image data in order of playback from the encoded data sequences in the MPEG-4 AVC format generated by the image processing device 400 in Embodiment 4. The image processing device reads out encoded difference data as well from the extended area of the encoded long exposure image data only when a slow playback or the like is to be performed.

To play back at a normal rate, the image processing device of Embodiment 5 reads out encoded long exposure image data, obtains long exposure image data by decoding encoded long exposure image data, and displays the obtained long exposure image data. This enables the moving image to be displayed smoothly.

Further, upon receiving, from the user, a playback speed switch instruction (for example, an instruction to change to a slow playback) during a playback at a normal rate, the image processing device of Embodiment 5 operates as follows to perform the specified playback starting with a piece of encoded short exposure image data that corresponds to a piece of long exposure image data immediately after a piece of long exposure image data at which the normal playback stops.

That is to say, the image processing device of Embodiment 5 reads out a piece of encoded long exposure image data that corresponds to a piece of long exposure image data immediately after a piece of long exposure image data at which the normal playback stops, reads out encoded difference data from the extended area of the piece of encoded long exposure image data, decodes the read-out data, obtains short exposure image data by combining long exposure image data and difference data obtained by the decoding, and displays the obtained short exposure image data.

When a slow playback or the like is performed in this way using the short exposure image data, a clear, less-blurred image is displayed.

### <Structure>

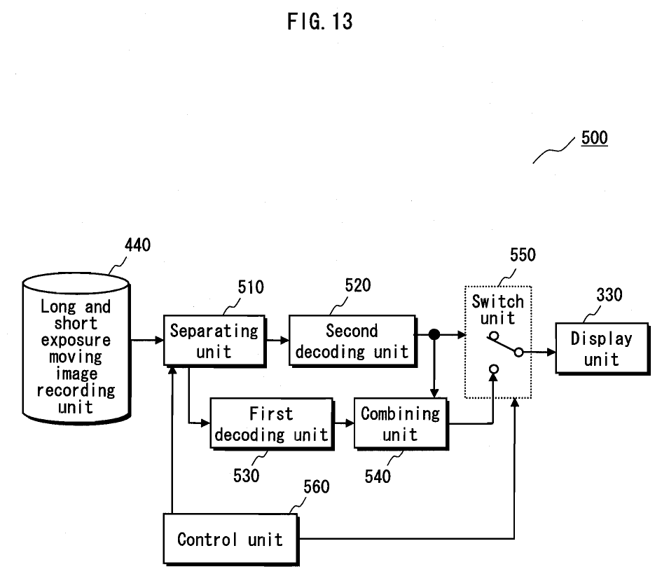

FIG. 13 is a functional block diagram of an image processing device 500 in Embodiment 5 of the present invention.

As shown in FIG. 13, the image processing device 500 includes a display unit 330, a long and short exposure moving image recording unit 440, a separating unit 510, a second decoding unit 520, a first decoding unit 530, a combining unit 540, a switch unit 550, and a control unit 560.

Here, description of the display unit 330 is omitted since it is the same as that included in the image processing device 300 in Embodiment 3. Also, the long and short exposure moving image recording unit 440 is the same as that included in the image processing device 400 in Embodiment 4 and stores encoded data sequences in the MPEG-4 AVC format.

The separating unit 510 has a function to separate each piece of encoded long exposure image data and each piece of encoded difference data from the encoded data sequences in the MPEG-4 AVC format stored in the long and short exposure moving image recording unit 440, and transmit the separated pieces of encoded long exposure image data and encoded difference data to the second decoding unit 520 and the first decoding unit 530, respectively.

More specifically, the separating unit 510 reads out the encoded data sequences in the MPEG-4 AVC format from the long and short exposure moving image recording unit 440, separates pieces of encoded long exposure image data in order of playback, and transmits the separated pieces of encoded long exposure image data to the second decoding unit 520. The separating unit 510 also separates a piece of encoded difference data from the extended area of a piece of encoded long exposure image data in accordance with an instruction by the control unit 560, and transmits the separated piece of encoded difference data to the first decoding unit 530.

The second decoding unit 520 has a function to obtain long exposure image data by decoding the encoded long exposure image data received from the separating unit 510, and outputs the obtained long exposure image data. Description of the decoding method used by the second decoding unit 520 is omitted here since it may be any of conventional methods used in image processing devices that can decode encoded data sequences in the MPEG-4 AVC format.

The first decoding unit 530 has a function to obtain difference data by decoding the encoded difference data received from the separating unit 510, and outputs the obtained difference data to the combining unit 540. Description of the decoding method used by the first decoding unit 530 is also omitted since it may be any of conventional methods used in image processing devices that can decode encoded data that has been encoded by the variable length encoding method or the like.

The combining unit 540 includes a combiner (not-illustrated), and has a function to restore short exposure image data that corresponds to the long exposure image data, by combining the difference data received from the first decoding unit 530 with the long exposure image data output from the second decoding unit 520, and outputs the restored short exposure image data.

Description of the combining performed here is omitted since it is the same as the combining performed by the image combining unit 130 of the image processing device 100 in Embodiment 1.

The switch unit 550, under the control of the control unit 560, transmits either the long exposure image data output from the second decoding unit 520 or the short exposure image data output from the combining unit 540 to the display unit 330.

The control unit 560 includes a processor and a memory (that are not illustrated), and has a function to control the separating unit 510 and the switch unit 550 in accordance with an instruction that is received from the user via an operation unit (not illustrated). The function of the control unit 560 is achieved in a software-like manner when the processor executes a control program stored in the memory.

More specifically, upon receiving a playback instruction or a playback speed switch instruction from the user, when the playback speed specified in the instruction is equal to or higher than a predetermined threshold value (for example, a value indicating a normal rate), the control unit 560 controls the separating unit 510 not to transmit the encoded difference data to the first decoding unit 530, namely, controls the separating unit 510 such that only the separated pieces of encoded long exposure image data are decoded by the second decoding unit 520. Further, the control unit 560 controls the switch unit 550 to transmit long exposure image data output from the second decoding unit 520, to the display unit 330.

When the playback speed specified in the instruction is smaller than the predetermined threshold value, the control unit 560 controls the separating unit 510 to transmit the encoded difference data to the first decoding unit 530, namely, controls the separating unit 510 such that the separated pieces of encoded long exposure image data are decoded by the second decoding unit 520 and the separated pieces of encoded difference data are decoded by the first decoding unit 530, respectively. Further, the control unit 560 controls the switch unit 550 to transmit short exposure image data output from the combining unit 540, to the display unit 330.

When it receives a stop instruction from the user via an operation unit, the control unit 560 performs a control to cause the separating unit 510 to stop reading the encoded data sequences in the MPEG-4 AVC format, so that the playback process is ended.

### <Operation>

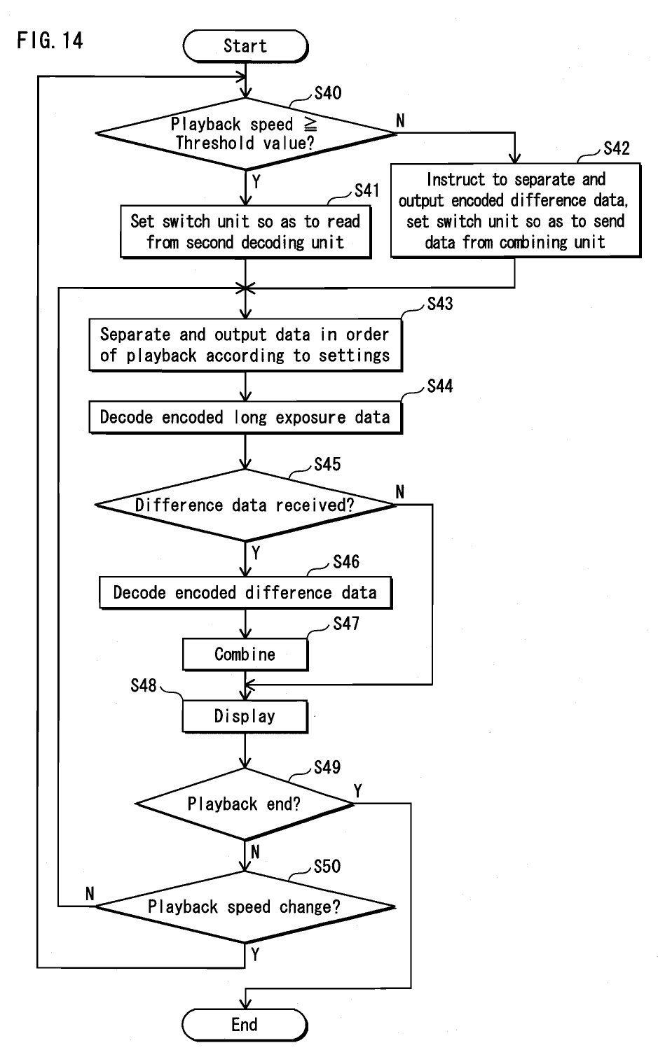

The following describes the operation of the image processing device 500 with the above-stated structure, with reference to FIG. 14.

FIG. 14 is a flowchart showing the operation of the image processing device 500.

The control unit 560 judges whether or not the playback speed that is specified in a playback instruction received from the user via an operation unit (not illustrated) is equal to or higher than a predetermined threshold value (step S40).

When it judges that the playback speed is equal to or higher than the predetermined threshold value (“Y” in step S40), the control unit 560 controls the switch unit 550 to transmit long exposure image data output from the second decoding unit 520 to the display unit 330 (step S41).

When it judges that the playback speed is lower than the predetermined threshold value (“N” in step S40), the control unit 560 controls the separating unit 510 to separate encoded difference data as well, and controls the switch unit 550 to transmit short exposure image data output from the combining unit 540 to the display unit 330 (step S42).

The separating unit 510 reads out encoded data sequences in the MPEG-4 AVC format from the long and short exposure moving image recording unit 440, separates pieces of encoded long exposure image data in order of playback, and transmits the separated pieces of encoded long exposure image data to the second decoding unit 520. The separating unit 510 also separates pieces of encoded difference data from the extended areas of pieces of encoded long exposure image data, and transmits the encoded difference data to the first decoding unit 530, when the instruction to do so is set in step S42 (step S43).

The second decoding unit 520 obtains long exposure image data by decoding the encoded long exposure image data received from the separating unit 510, and outputs the obtained long exposure image data (step S44).

When it has received encoded difference data from the separating unit 510 (“Y” in step S45), the first decoding unit 530 transmits difference data, which is obtained by decoding the received encoded difference data, to the combining unit 540 (step S46).

The combining unit 540 restores short exposure image data by combining the difference data received from the first decoding unit 530 with the long exposure image data output from the second decoding unit 520, and outputs the restored short exposure image data (step S47).

The switch unit 550, under the control of the control unit 560, transmits either the long exposure image data output from the second decoding unit 520 or the short exposure image data output from the combining unit 540 to the display unit 330, and the display unit 330 displays the received image data (step S48). That is to say, the long exposure image data is displayed when the switch unit 550 is set in step S41, and the short exposure image data is displayed when the switch unit 550 is set in step S42.

The control unit 560 judges whether or not a stop instruction has been received from the user via the operation unit (step S49). When it judges that the stop instruction has been received (“Y” in step S49), the control unit 560 ends the playback process. When it judges that the stop instruction has not been received (“N” in step S49), the control unit 560 judges whether or not a playback speed change instruction has been received from the user via the operation unit (step S50).

When it judges that the playback speed change instruction has not been received (“N” in step S50), the control unit 560 returns to step S43 to continue the process. When it judges that the playback speed change instruction has been received (“Y” in step S50), the control unit 560 returns to step S40 to continue the process.

With this structure, when, for example, the predetermined threshold value has been set to a value indicating a normal rate, and when the control unit 560 receives, from the user, a playback instruction to play back at the normal rate, only the pieces of encoded long exposure image data are separated from the encoded data sequences in the MPEG-4 AVC format, decoded, and displayed.

Also, when the control unit 560 receives, from the user, an instruction to change to a slow playback or to a pause during a playback at a normal rate, separated, output, and decoded are a piece of long exposure image data immediately after a piece of long exposure image data at which the normal playback stops, and a piece of encoded difference data stored in the extended area of the piece of long exposure image data, and a piece of short exposure image data is restored from the long exposure image data and the difference data, and the restored short exposure image data is displayed.

Accordingly, the image processing device 500 of the present embodiment produces the same advantageous effects as the image processing device 300 in Embodiment 3.

### <Supplemental Notes>

(1) According to the above-description of the image processing device 100 of Embodiment 1, the long exposure image data and the short exposure image data are consecutively recorded into consecutive areas in the long exposure image recording unit 150 and the short exposure image recording unit 160, respectively. However, not limited to this, each piece of image data may be recorded together with information that indicates a position of the piece of image data in the order of generation.

With this arrangement, it is possible to identify a piece of long exposure image data and a piece of short exposure image data that correlate with each other in that they have the same position in the order of generation. Also, when the moving image data is played back, the order of playback can be identified from the order of generation.

(2) According to the above-description of the image processing device 100 of Embodiment 1, the imaging unit 110, the counter 131, and the comparator 141 operate based on the exposure time, the imaging rate, the combination number, the selection number and the like that are set preliminarily by the control unit 170. However, these settings may be set dynamically by the control unit 170 while images are taken.

With this arrangement, the control unit 170 can temporarily raise the imaging rate of the imaging unit 110 to take images having special effects.

(3) According to the above-description of the image processing device 100 of Embodiment 1, each piece of short exposure image data is generated by selecting one from among a predetermined number of frames of image data to be combined. However, not limited to this, each piece of short exposure image data is generated by combining a plurality of frames of image data.

In this case, to generate each piece of short exposure image data with a total exposure time of, for example, 1/270 seconds as in Embodiment 1, the imaging unit 110 needs to be replaced with another unit that takes images with an exposure time (for example, 1/540 seconds) that is shorter than the total exposure time. In this example, each piece of short exposure image data is generated by combining two frames of image data.

(4) According to the above-description of the image processing device of Modification 1, the imaging unit can perform image taking with the exposure time A (for example, 1/67.5 seconds) and with the exposure time B (for example, 1/270 seconds). However, not limited to this, the exposure time A may be extended to be longer than this example.

For example, the exposure time A may be set to be equivalent with the total exposure time of the long exposure image data (for example, 1/30 seconds). This will eliminate the need to combine a plurality of frames of image data to generate a piece of long exposure image data, and a piece of long exposure image data can be generated by selecting a frame of image data taken with the exposure time A. This can eliminate the amount of process required for the combining.

(5) According to the above-description of the image processing device 100 of Embodiment 1 and the image processing device of Modification 1, generated are two types of sets of image data (a set of long exposure image data and a set of short exposure image data) that are different from each other in the total exposure time. However, not limited to this, three or more types of sets of image data that are different from each other in the total exposure time may be generated.

For example, a set of image data whose total exposure time is between the long exposure time and the short exposure time (hereinafter, such a set of image data is referred to as “set of intermediate exposure image data”) may be generated from each set of a plurality of (for example, nine) frames of image data, where each set of intermediate exposure image data is generated by combining three frames of image data that include a frame of image data that is positioned at the center of the plurality of frames of image data and two frames of image data that are before and after the center frame in order of transmission from the imaging unit.

In this case, the image processing device 200 of Embodiment 2 may be modified to process the three types of image data (to compress encode the intermediate exposure image data by using motion vectors that were detected using the short exposure image data), and to generate three types of encoded data sequences in the MPEG-4 AVC format.

Also, the image processing device 300 of Embodiment 3 may be modified to switch the display among the three types of encoded data sequences in the MPEG-4 AVC format depending on the playback speed so that it can respond to three or more levels of playback speed.

For example, for a playback at the normal rate, encoded long exposure image data sequences in the MPEG-4 AVC format are played back; for a slow playback at ½ of the normal rate, encoded intermediate exposure image data sequences in the MPEG-4 AVC format are played back; and for a pause or a slow playback at ¼ of the normal rate, encoded short exposure image data sequences in the MPEG-4 AVC format are played back.

(6) According to the above-description of the image processing device 200 of Embodiment 2, encoded data sequences in the MPEG-4 AVC format are generated from the set of long exposure image data and the set of short exposure image data, which are generated by the image processing device 100 of Embodiment 1 and are respectively stored in the long exposure image recording unit 150 and the short exposure image recording unit 160. However, not limited to the image data generated by the image processing device 100 of Embodiment 1, encoded data sequences in the MPEG-4 AVC format may be generated from a set of long exposure image data and a set of short exposure image data received from an external source, where the received sets of long exposure image data and short exposure image data may have been made by the same method as, or by a method that is different from, the method used by the image processing device 100 of Embodiment 1.

Here, the set of long exposure image data and the set of short exposure image data, from which encoded data sequences in the MPEG-4 AVC format are generated by the image processing device 200 of Embodiment 2, only need to satisfy the following conditions.

That is to say, short exposure image data whose total exposure time is the first time (for example, 1/270 seconds) and long exposure image data whose total exposure time is the second time (for example, 1/30 seconds) being different from the first time, where each piece of short exposure image data is correlated with a piece of long exposure image data whose total exposure time includes the total exposure time of the piece of short exposure image data, and each pair of short exposure image data and long exposure image data, which correlate with each other, is correlated with information that identifies a position in order of playback. This applies to the image processing device 400 in Embodiment 4.

(7) According to the above-description of the image processing device 200 of Embodiment 2, motion vectors of each piece of short exposure image data are detected, and encoded data sequences in the MPEG-4 AVC are generated by compress encoding each piece of short exposure image data and corresponding pieces of long exposure image data using the detected motion vectors. However, conversely, motion vectors of each piece of long exposure image data may be detected, and encoded data sequences in the MPEG-4 AVC may be generated by compress encoding each piece of long exposure image data and corresponding pieces of short exposure image data using the detected motion vectors.

(8) According to the above-description of the image processing device 200 of Embodiment 2, motion vectors of each piece of short exposure image data are detected, and each piece of short exposure image data and corresponding pieces of long exposure image data are compress encoded using the detected motion vectors. However, not limited to this, the following modification is available.

That is to say, in addition to compress encoding each piece of short exposure image data using motion vectors detected from said each piece of short exposure image data, the corresponding pieces of long exposure image data may be searched for motion vectors again, using the motion vectors (detected from the short exposure image data) as the initial values. That is to say, surrounding areas of macro blocks (which are pointed to by the motion vectors detected from the short exposure image data) on the reference images of long exposure image data are searched for motion vectors again. Then, the long exposure image data is compress encoded using the motion vectors detected by the re-search.

With this structure where the long exposure image data is searched for motion vectors again, it is highly possible that motion vectors with high accuracy are detected. Accordingly, this would further improve the compression rate.

The execution of re-searching motion vectors increases the amount of process, compared with the image processing device 200 of Embodiment 2. However, compared with the case where motion vectors are detected from the long exposure image data separately without using the motion vectors detected from the short exposure image data as the initial values, it is possible to search efficiently the long exposure image data for motion vectors, thus it is possible to reduce the amount of process for the compress encoding of the image processing device as a whole.

Also, the above-description of this modification provides an example where, the long exposure image data is searched for motion vectors again, using the motion vectors detected from the corresponding short exposure image data as the initial values. However, not limited to this, the converse is possible. That is to say, first, motion vectors may be detected from the long exposure image data, then, the corresponding short exposure image data may be searched for motion vectors again, using the motion vectors detected from the long exposure image data as the initial values.

(9) According to the above-description of the image processing device 200 of Embodiment 2, encoded short exposure image data sequences in the MPEG-4 AVC format are generated by compress encoding each piece of short exposure image data, using the motion vectors detected from the short exposure image data. However, not limited to this, encoded short exposure image data sequences in the MPEG-4 AVC format may not be generated.

That is to say, each piece of short exposure image data may be used only to detect motion vectors that are used for compress encoding the long exposure image data. Each piece of short exposure image data is a frame of image data that was generated with a short exposure time, and represents a clear image with less blurring. It is thus highly possible that motion vectors with high accuracy are detected from each piece of short exposure image data. Accordingly, it is expected that this improves the image quality in an image processing device (moving image playback device) that performs what is called “interframe interpolation” when it plays back an encoded data sequence in the MPEG-4 AVC format.

Also, since each frame of image data represents a clear image with less blurring, it is highly possible that a motion vector that matches the actual movement of the object is detected. When a motion vector that matches the actual movement of the object can be detected, another modification becomes possible where what is called global vector is identified, and the identified global vector is used for correcting a camera shake or the like.

(10) According to the above-description, the image processing device 300 of Embodiment 3 plays back moving images by playing back encoded data sequences in the MPEG-4 AVC format that are generated by the image processing device 200 of Embodiment 2 and are stored in the long exposure moving image recording unit 240 and the short exposure moving image recording unit 250. However, not limited to the image data generated by the image processing device 200 of Embodiment 2, encoded data sequences in the MPEG-4 AVC format for playback may be received from an external source.

That is to say, the encoded data sequences in the MPEG-4 AVC format that are used for playback by the image processing device 300 of Embodiment 3 may be any encoded data sequences in the MPEG-4 AVC format as far as they are results of compress encoding the long and short exposure image data that correspond to each other and satisfy the conditions described in (6) above, using motion vectors that are detected from one of the long and short exposure image data.

(11) With regards to the image processing devices of the above-described embodiments and modifications, part or all of the constituent elements thereof shown in FIGS. 1, 5, 8, 10, and 13 may be achieved by one chip or a plurality of chips, or may be achieved in a form of a computer program or in any other forms.

(12) According to the above-description, the image processing devices of Embodiments 2-5 and Modification 2 conform to the MPEG-4 AVC standard. However, not limited to this, the devices may conform to other standards (for example, MPEG-1, MPEG-2, and MPEG-4).

(13) In the above embodiments and modifications, the image processing devices are described as separate devices. However, not limited to this, for example, the image processing devices in Embodiments 1-3, the image processing devices in Modification 1 and Embodiments 2 and 3, the image processing devices in Embodiments 1, 4 and 5, the image processing devices in Modification 2 and Embodiments 1 and 5, the image processing devices in Modification 1 and Embodiments 4 and 5, or the image processing devices in Modifications 1 and 2 and Embodiment 5 may be achieved as one image processing device.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image processing device comprising:
an imaging unit operable to output frames of image data sequentially in order of imaging;
a first generation unit operable to generate pieces of first image data sequentially in units of a predetermined number of consecutive frames of image data, from the frames of image data output sequentially from the imaging unit, wherein a total exposure time of each piece of first image data is a first time period;
a second generation unit operable to generate pieces of second image data sequentially in units of the predetermined number of consecutive frames of image data, from the frames of image data output sequentially from the imaging unit, wherein a total exposure time of each piece of second image data is a second time period different from the first time period; and
an output unit operable to, for each pair of a piece of first image data and a piece of second image data that are generated from a same set of the predetermined number of consecutive frames of image data, output the piece of first image data and the piece of second image data in correlation with each other.

2. The image processing device of claim 1, wherein
each piece of first image data generated by the first generation unit is one frame of image data selected from each set of the predetermined number of consecutive frames of image data,
each piece of second image data generated by the second generation unit is combined image data that is generated by combining two or more frames of image data including a corresponding piece of first image data, among the predetermined number of consecutive frames of image data, and
the output unit assigns a sequential number indicating a predetermined order to at least one of the piece of first image data and the piece of second image data in each pair that are to be correlated with each other and are to be output.

3. The image processing device of claim 2, wherein
the two or more frames of image data that are combined by the second generation unit are three or more frames of image data that include, among the predetermined number of frames of image data, two frames of image data that are before and after the corresponding piece of first image data in order of output from the imaging unit.

4. The image processing device of claim 3, wherein
the predetermined number is an odd number,
said one frame of image data selected by the first generation unit is, among the predetermined number of frames of image data, a frame of image data that is positioned at center of a sequence of frames of image data arranged in order of output from the imaging unit, and
the three or more frames of image data that are combined by the second generation unit are all of the predetermined number of frames of image data.

5. The image processing device of claim 2, wherein
the imaging unit generates each frame of image data with a same exposure time as the first time period, and outputs the generated frame of image data.

6. The image processing device of claim 2, wherein
each of the predetermined number of frames of image data is generated by the imaging unit either with a same exposure time as the first time period or with an exposure time that is a third time period different from the first time period, and
said one frame of image data selected by the first generation unit is, among the predetermined number of frames of image data, a frame of image data that has been generated with the same exposure time as the first time period.

7. The image processing device of claim 6, wherein
the first time period is shorter than the third time period.

8. The image processing device of claim 2 further comprising:
a first motion vector detecting unit operable to detect a first motion vector from each piece of first image data output from the output unit; and
a first compress encoding unit operable to compress encode each piece of second image data output from the output unit, using each first motion vector detected by the first motion vector detecting unit from each corresponding piece of first image data.

9. The image processing device of claim 2 further comprising:
a difference extracting unit operable to generate difference data that shows difference between each piece of first image data and each corresponding piece of second image data output from the output unit; and
a compress encoding unit operable to compress encode each piece of difference data output from the difference extracting unit.

10. The image processing device of claim 1, wherein
the imaging unit generates each frame of image data with an exposure time that is a third time period shorter than the first time period, and outputs the generated frame of image data,
each piece of first image data generated by the first generation unit is combined image data that is generated by combining two or more frames of image data among the predetermined number of frames of image data, and
each piece of second image data generated by the second generation unit is combined image data that is generated by combining three or more frames of image data including the two or more frames of image data that are combined by the first generation unit.

11. The image processing device of claim 1 further comprising:
a first motion vector detecting unit operable to detect a first motion vector from each piece of first image data output from the output unit; and
a first compress encoding unit operable to compress encode each piece of second image data output from the output unit, using each first motion vector detected by the first motion vector detecting unit from each corresponding piece of first image data.

12. The image processing device of claim 11 further comprising
a second compress encoding unit operable to compress encode each piece of first image data output from the output unit, using each first motion vector detected by the first motion vector detecting unit from said each piece of first image data.

13. The image processing device of claim 12, wherein
the output unit assigns a sequential number indicating a predetermined order to at least one of each piece of first image data and each piece of second image data that correlate with each other and are to be output,
the image processing device further comprising:
a decoding unit operable to generate image data by decoding either each piece of encoded first image data encoded by the second compress encoding unit, or each piece of encoded second image data encoded by the first compress encoding unit, and output the generated image data;
a playback unit operable to play back the image data output from the decoding unit;
a receiving unit operable to receive an instruction for changing a playback speed; and
a decoding control unit operable to, when the playback unit is playing back a piece of first image data when the receiving unit receives the instruction for changing the playback speed, cause the decoding unit to decode a piece of encoded second image data that is generated by encoding a piece of second image data corresponding to a piece of first image data that is, in the predetermined order, immediately after the piece of first image data being played back, and operable to, when the playback unit is playing back a piece of second image data, cause the decoding unit to decode apiece of encoded first image data that is generated by encoding a piece of first image data corresponding to a piece of second image data that is, in the predetermined order, immediately after the piece of second image data being played back.

14. The image processing device of claim 11 further comprising:
a second motion vector detecting unit operable to detect a second motion vector from each piece of second image data output from the output unit, using each first motion vector detected from each corresponding piece of first image data, wherein
the first compress encoding unit compress encodes each piece of second image data output from the output unit, using each second motion vector detected from said each piece of second image data.

15. The image processing device of claim 1 further comprising:
a motion vector detecting unit operable to detect a motion vector from each piece of second image data output from the output unit;
a first compress encoding unit operable to compress encode each piece of first image data output from the output unit, using each motion vector detected by the motion vector detecting unit from each corresponding piece of second image data; and
a second compress encoding unit operable to compress encode each piece of second image data output from the output unit, using each motion vector detected from said each piece of second image data.

16. The image processing device of claim 1 further comprising:
a difference extracting unit operable to generate difference data that shows difference between each piece of first image data and each corresponding piece of second image data output from the output unit; and
a first compress encoding unit operable to generate encoded difference data by compress encoding each piece of difference data output from the difference extracting unit.

17. The image processing device of claim 16 further comprising
a second compress encoding unit operable to generate pieces of encoded second image data by compress encoding each piece of second image data output from the output unit, and output the generated pieces of encoded second image data in correspondence with encoded difference data that have been generated by compress encoding pieces of difference data that respectively show difference from pieces of second image data from which the pieces of encoded second image data are generated.

18. The image processing device of claim 17, wherein
the output unit assigns a sequential number indicating a predetermined order to at least one of each piece of first image data and each piece of second image data that correlate with each other and are to be output,
the image processing device further comprising:
a decoding unit operable to generate second image data by decoding one of a plurality of pieces of encoded second image data encoded by the second compress encoding unit and output the generated second image data, or further generate difference data by decoding encoded difference data corresponding to the plurality of pieces of encoded second image data, and output the generated difference data and the generated second image data;
a combining unit operable to generate first image data by combining the difference data and the second image data output from the decoding unit, and output the generated first image data;
a playback unit operable to play back either the second image data output from the decoding unit or the first image data output from the combining unit;
a receiving unit operable to receive an instruction for changing a playback speed; and
a decoding control unit operable to, when the playback unit is playing back a piece of first image data when the receiving unit receives the instruction for changing the playback speed, cause the decoding unit to decode a piece of encoded second image data that is generated by encoding a piece of second image data corresponding to a piece of first image data that is, in the predetermined order, immediately after the piece of first image data being played back, and operable to, when the playback unit is playing back a piece of second image data, cause the decoding unit to decode a piece of encoded second image data that is generated by encoding a piece of second image data that is, in the predetermined order, immediately after the piece of second image data being played back, and cause the decoding unit to decode a piece of encoded difference data that correspond to the decoded piece of second image data.

19. The image processing device of claim 1, wherein
the output unit assigns a sequential number indicating a predetermined order to at least one of each piece of first image data and each piece of second image data that correlate with each other and are to be output,
the image processing device further comprising:
a playback unit operable to play back either the first image data or the second image data output from the output unit;
a receiving unit operable to receive an instruction for changing a playback speed; and
a playback control unit operable to, when the playback unit is playing back apiece of first image data when the receiving unit receives the instruction for changing the playback speed, cause the playback unit to play back a piece of second image data that correspond to a piece of first image data that is, in the predetermined order, immediately after the piece of first image data being played back, and operable to, when the playback unit is playing back a piece of second image data, cause the playback unit to play back a piece of first image data that correspond to a piece of second image data that is, in the predetermined order, immediately after the piece of second image data being played back.

20. An image processing device comprising:
an obtaining unit operable to sequentially obtain pairs of a piece of first image data and a piece of second image data which correlate with each other, in a predetermined order, from among a plurality of pieces of first image data and a plurality of pieces of second image data that are stored in an external storage device in correspondence with each other, wherein a total exposure time of each piece of first image data is a first time period, a total exposure time of each piece of second image data is a second time period different from the first time period, and a sequential number indicating the predetermined order is assigned to at least one of each piece of first image data and each piece of second image data that correlate with each other;
a motion vector detecting unit operable to detect a motion vector from each piece of first image data obtained by the obtaining unit;
a first compress encoding unit operable to compress encode each piece of second image data obtained by the obtaining unit, using each motion vector detected by the motion vector detecting unit; and
a second compress encoding unit operable to compress encode each piece of first image data obtained by the obtaining unit, using each motion vector detected by the motion vector detecting unit.

21. An image processing device comprising:
an obtaining unit operable to sequentially obtain pairs of a piece of first image data and a piece of second image data which correlate with each other, in a predetermined order, from among a plurality of pieces of first image data and a plurality of pieces of second image data that are stored in an external storage device in correspondence with each other, wherein a total exposure time of each piece of first image data is a first time period, a total exposure time of each piece of second image data is a second time period different from the first time period, and a sequential number indicating the predetermined order is assigned to at least one of each piece of first image data and each piece of second image data that correlate with each other;
a difference extracting unit operable to generate difference data that shows difference between each piece of first image data and each corresponding piece of second image data obtained by the obtaining unit; and
a compress encoding unit operable to compress encode each piece of difference data output from the difference extracting unit.

22. An image processing device comprising:
an obtaining unit operable to obtain either a piece of first image data or a piece of second image data from among a plurality of pieces of first image data and a plurality of pieces of second image data that are stored in an external storage device in correspondence with each other, wherein a total exposure time of each piece of first image data is a first time period, a total exposure time of each piece of second image data is a second time period different from the first time period, and a sequential number indicating the predetermined order is assigned to at least one of each piece of first image data and each piece of second image data that correlate with each other;
a playback unit operable to play back image data obtained by the obtaining unit;
a receiving unit operable to receive an instruction for changing a playback speed; and
an obtaining control unit operable to, when the playback unit is playing back apiece of first image data when the receiving unit receives the instruction for changing the playback speed, cause the obtaining unit to obtain a piece of second image data corresponding to a piece of first image data that is, in the predetermined order, immediately after the piece of first image data being played back, and operable to, when the playback unit is playing back a piece of second image data, cause the obtaining unit to obtain a piece of first image data corresponding to a piece of second image data that is, in the predetermined order, immediately after the piece of second image data being played back.

23. The image processing device of claim 22, wherein
the instruction for changing the playback speed received by the receiving unit specifies a playback speed after change, and
the obtaining control unit, when the playback unit is playing back a piece of second image data when the receiving unit receives the instruction specifying a playback speed after change that is smaller than a first threshold value, causes the obtaining unit to obtain a piece of first image data corresponding to a piece of second image data that is, in the predetermined order, immediately after the piece of second image data being played back, and when the playback speed after change specified in the instruction received by the receiving unit is equal to or greater than the first threshold value, causes the obtaining unit to obtain a piece of second image data that is, in the predetermined order, immediately after the piece of second image data being played back.

24. The image processing device of claim 23, wherein
the obtaining control unit, when the playback unit is playing back a piece of first image data when the receiving unit receives the instruction specifying a playback speed after change that is equal to or greater than a second threshold value that is greater than the first threshold value, causes the obtaining unit to obtain a piece of second image data corresponding to a piece of first image data that is, in the predetermined order, immediately after the piece of first image data being played back, and when the playback speed after change specified in the instruction received by the receiving unit is smaller than the second threshold value, causes the obtaining unit to obtain a piece of first image data that is, in the predetermined order, immediately after the piece of first image data being played back.
